(19) United States
(12) Patent Application Publication
(10) Pub. No.: US 2005/0182902 A1
(43) Pub. Date: Aug. 18, 2005

(54) Signal processing apparatus

(76) Inventor: Shuji Miyasaka, Neyagawa-shi (JP)

Correspondence Address: WENDEROTH, LIND & PONACK, L.L.P., 2033 K STREET N. W., SUITE 800, WASHINGTON, DC, 20006-1021, US

(21) Appl. No.: 11/052,979

(22) Filed: Feb. 9, 2005

(30) Foreign Application Priority Data
Feb. 12, 2004 (JP) 2004-035429

(51) Int. Cl. G06F 12/08

(52) U.S. Cl. 711/118; 711/128; 711/144

(57) ABSTRACT

A signal processing apparatus (1) performs decoding using a first memory area (11) of a main memory (10), a first table (13) of a second memory area (12) and a second table (14). The signal processing apparatus (1) has a cache memory (34) for temporarily storing data of the first table (13) and the second table (14), a processor (20) which reads out the data by accessing at least one of the first memory area (11) and the second memory area (12) via the cache memory (34), and a control unit (51) which allocates a space in the cache memory (34) when there is no space for temporarily storing in the cache memory (34). The control unit (51) allocates the space in the cache memory (34) into which the data in the first memory area (11) is stored preferentially to the data in the second memory area (12).

### BACKGROUND OF THE INVENTION

(1) Field of the Invention

The present invention relates to a signal processing apparatus which performs signal processing using data in first and second memory areas, in particular to a signal processing apparatus which accesses the first and second memory areas via a cache memory and processes a signal by reading data in the first and second memory areas.

(2) Description of the Related Art

For example, a signal processing is performed on music data, by which the music data is encoded into a Huffman code using, for instance, a Huffman code book (e.g. 8) on a MPEG-AAC standard and the encoded data is decoded when the music data is reproduced.

FIG. 1 shows a Huffman code book 8 on a MPEG-AAC standard.

Hereafter, it is explained about how Huffman decoding is performed using the code book.

For example, assume that a Huffman coded input bit string is “01110110000111111011010001111xxxx”.

Herein, first 5 bits match the first entry “01110” in the table. Therefore, it is found that the result of decoding is “0” and the code length is 5 bits. Further, the following bits are “110000111111011010001111xxxx” so that the first 6 bits match the fourth entry “110000” in the table. Therefore, the table shows that the result of decoding is “3” and the code length is 6 bits. Further, the next following bits are “111111011010001111xxxx” so that the first 9 bits match the third entry “111111011” from the last of the table. Therefore, the table shows that the result of decoding is “61” and the code length is “9”. Furthermore, the following bits are “010001111xxxx” so that the first 4 bits match the eleventh entry “0100” of the table “0100”. Therefore, the table shows that the result of decoding is “10” and the code length is 4 bits. Further, the following bits are “01111xxxx” so that the first 5 bits match the seventeenth entry of “01111” in the table. Therefore, the table shows that the result of decoding is “16” and the code length is 5 bits.

The Huffman decoding is thus performed by searching every line on the Huffman code book 8.

However, this decoding method needs to search the Huffman code book 8 again and again until a matched Huffman code is found. Therefore, there is a problem that it requires a large amount of time for processing.

Therefore, the inventor according to the present invention has invented a device for performing the Huffman decoding in high speed (e.g. refer to Japanese Laid-Open Patent publication 2000-286717).

Hereafter, it is explained about a conventional technology to which the invention is applied using, as an example, a procedure of decoding an encoded code using the Huffman code book 8 on the MPEG-AAC standard.

FIG. 2 is a diagram showing two tables for performing the Huffman decoding in high speed. In particular, FIG. 2A shows a first table 5000 and FIG. 2B shows a second table 6000.

These first and second tables 5000 and 6000 are stored in predetermined addresses in a memory such as SRAM. A decoder performs decoding by searching the first and second tables 5000 and 6000 based on a bit string of a Huffman code.

In the case where the first and second tables 5000 and 6000 are used, an input bit string is decoded as follows.

For example, an input bit continues as “01110110000111111011010001111xxxx” as used in the prior example, the decoder first takes out first 6 bits and searches the first table 5000 using the 6 bits as an address. Herein, it searches the first table 5000 using “011101” as the address. Therefore, the decoder accesses a first access point α1 shown in FIG. 2A. From the access point, it is found that the code length is 5 bits and the result of decoding is “0”. The decoder then removes the codes composed of 5 bits from the bit string since the code length is 5 bits. The updated bit string then becomes “110000111111011010001111xxxx”.

Next, similarly, the decoder takes out first 6 bits of the bit string and searches the first table 5000 using the 6 bits as an address. Herein, the decoder searches the first table 5000 using “110000” as the address so that it accesses a second access point α2 shown in FIG. 2A. From the access point, it is found that the code length is 6 bits and the result of decoding is “3”. Since the code length is 6 bits, the decoder then removes the codes composed of 6 bits from the bit string and obtains the bit string of “111111101110001111xxxx”.

Further, the decoder similarly takes out the first 6 bits of the bit string and searches the first table 5000 using the 6 bits as an address. Herein, the decoder searches the first table 5000 using “111111” as the address so that the decoder accesses a third access point α3 as a third access point shown in FIG. 2A so as to obtain an incomplete symbol “15”, a next address pointer “1100010”, and a number of bits to be read next “4”. The decoder therefore moves the pointer to the address “1100010” in the second table 60000 shown in FIG. 2B and obtains further 4 bits after removing the codes composed of 6 bits from the bit string. It searches the second table 6000 using the 4 bits as an index from the address “1100010”. Herein, the value of said 4 bits is “0110” so that the decoder accesses a fourth access point α4 shown in FIG. 2B. From the access point, it is found that the code length is 3 bits and the result of decoding is “61”. The decoder then removes the codes composed of 3 bits from the bit string since the code length is 3 bits. The updated bit string “01000111xxxx” is thus obtained.

Next, the decoder similarly takes out first 6 bits of the bit string and searches the first table 5000 using the 6 bits as an address. Herein, the decoder searches the first table 5000 using “010001” as the fifth access point α5 shown in FIG. 2A. From the access point, it is found that the code length is 4 bits and the result of decoding is “10”. Since the code length is 4 bits, the decoder removes the codes composed of 4 bits from the bit string and then obtains the bit string of “01111xxxx”.

Furthermore, the decoder similarly takes out first 6 bits of the bit string and searches the first table 5000 using the 6 bits as an address. Herein, the decoder searches the first table 5000 using “01111x” as the address so that it accesses a sixth access point α6 shown in FIG. 2A. From the access point, it is found that the code length is 5 bits and the result of decoding is “16”.

As is clear from the procedure of the processing, the Huffman decoding is completed for a code with short code length (code which is more frequenty occurred) by accessing a table once. It is completed, on the other hand, for a code with long code length (code which is less frequenty occurred) by accessing a table twice. Consequently, high speed signal processing can be realized as an average of the two.

The above is the conventional technology invented by the present inventor and some.

By the way, in recent years, a computer apparatus such as a cellular phone seeks multifunction with which it can not only make a phone call and reproduce audio, but also reproduce video, transmit and receive an electronic mail.

In order to realize such multifunction, if a unique circuit is set for each function, the circuit scale becomes enormous. Therefore, it is sought to realize each function without decreasing responses by storing data in the table and the like into an external memory and the like if necessary and by storing the data stored in the external memory into a cache memory if necessary for signal processing.

There is a case when the Huffman decoding is performed in such arithmetic apparatus (signal processing apparatus) having a cache memory. It is explained about the conventional technology for that case. First, it is briefly explained about behavior of the cache memory.

FIG. 3 is a diagram indicating a relationship among a main memory 1000, a processor 2000 and a cache memory 3000.

As shown in FIG. 3, the cache memory device 3000 has a cache memory 3100 for holding data and a control unit 3200 for controlling a replacement.

In the cache memory 3100, data is managed by a unit called line. In general, the size of line is a value such as 32 bytes or 128 bytes, and the size of cache memory is a value such as 16 k bytes or 32 k bytes. The cache memory 3100 is separated with from thousands to hundreds. Here, in order to make an explanation easier, it is explained as if the cache memory 3100 is divided with four lines.

A storage area of the main memory 1000 is also separated by each line size. An area (tag area) 300 of tag information in the cache memory 3100 manages about what number of line of the main memory 1000 is stored where in data area 3400 of the cache memory 3100.

FIG. 3 shows that data of Line 1, Line 3, Line 6 and Line 8 in the main memory 1000 are stored in the data area 3400 of the cache memory 3100, and shows a state where information for identifying the lines is stored in a tag area 3300.

Accordingly, the processor 2000, in the case of accessing data of the lines (Line 1, Line 3, Line 6 and Line 8) of the main memory 1000, can process by accessing the cache memory 3100.

However, for example, in the case where the processor accesses the Line 9 of the main memory 1000, since the area is not stored in the cache memory 3100 and there is no space in the cache memory 3100 already, allocates a space in the cache memory 3100 by writing back data of one of lines stored in the cache memory 3100 temporarily into the main memory 1000, and stores data of the Line 9 into the space of the area.

When a signal processing apparatus having such cache memory 3100 performs the Huffman decoding as explained before, for example, in the case of an AAC method of MPEG audio, they requires large memory area so that the Huffman decoding is performed by storing all table data necessary for Huffman decoding in the main memory 1000 and sequentially transferring the data to the cache memory.

Here, accessing means to read out and write data by specifying an address, and the like.

However, when the signal processing apparatus using the cache memory performs the Huffman decoding, following problem is caused.

FIG. 4 is a block diagram showing a structure of a conventional signal processing apparatus in the case where the Huffman decoding using the cache memory 3100 is performed. Here, in order to precisely differentiate the signal processing apparatus according to the present invention with the conventional signal processing apparatus, it is explained about the case where the first and second tables 13 and 14 that are explained later are used as substitutes of the first and second tables 5000 and 6000.

As shown in FIG. 4, the signal processing apparatus has a main memory 1000, a processor 2000 as an access unit, and a cache memory 3100. A first table 13 is stored in a first memory area 1001 of the main memory 1000 and a second table 14 is stored in a second memory area 1002 of the main memory 1000.

The first table 13 is formed of 8 lines (Line 0 to Line 7) and the second table 14 is formed of 7 lines (Line 8 to Line 14). Specific details of the first table 13 and the second table 14 are respectively shown in FIG. 14 and FIG. 15. While the first table 13 and the second table 14 are tables which hold data that is similar in FIG. 2A and FIG. 2B shown as a conventional technology, they differ in that they are separated by each line size in accordance with a structure of the cache memory.

Here, when an input bit string continues as “011101100001111110110100011111xxxx” as similar in the prior example, the processor 2000 first searches the first table 13 using first 6 bits of the bit string as an address. Herein, it searches the first table 13 using “011101” as the address. The address applies to Line 3 as shown in FIG. 14. Therefore, after data of the Line 3 is transferred from the main memory 1000 to the cache memory 3100 (ref. FIG. 5), the processor 2000 accesses the data and finds that the code length is 5 bits and the result of decoding is “0”. Since the code length is 5 bits, the processor 2000 removes the codes composed of 5 bits from the bit string and the updated bit string of “110000111111011010001111xxxx” is obtained.

Next, the processor 2000 similarly searches the first table 13 using first 6 bits of the bit string as an address. Herein, it searches the first table 13 using “110000” as the address. The address applies to Line 6 as shown in FIG. 14. Therefore, after data of the Line 6 is transferred from the main memory 1000 to the cache memory 3100 (ref. FIG. 6), the processor 2000 accesses the data and obtains that the code length is 6 bits and the result of decoding is “3”. Since the code length is 6 bits, the processor 2000 removes the codes composed of 6 bits from the bit string and the updated bit string of “111111011010001111xxxx” is obtained.

Further, the processor 2000 similarly searches the first table 13 using first 6 bits of the bit string as an address. Herein, it searches the first table 13 using “111111” as the address. The address applies to Line 7 as shown in FIG. 14. Therefore, after data of the Line 7 is transferred from the main memory 1000 to the cache memory 3100 (ref. FIG. 7), the processor 2000 accesses the data and obtains an incomplete symbol “15”, a next address pointer “1100010”, and a number of bits “4” to be read next. The processor 2000 then moves a pointer to the address “1100010” in the second table 14, after removing the codes composed of 6 bits from the bit string, and searches the second table 14 using the value of following 4 bits as an index from the address “1100010”. Herein, the value of 4 bits is “0110” so that an address to be accessed next becomes “1101000” which is obtained by adding “0110” to the address “1100010”. That is, the processor 2000 adds “0110” to the next address pointer “1100010” so as to obtain the next accessing address “1101000” by calculation.

The address applies to Line 13 as shown in FIG. 15. Therefore, after data of the Line 13 is transferred from the main memory 1000 to the cache memory 3100 (ref. FIG. 8), the processor 2000 accesses the data, and obtains that the code length is 3 bits and the result of decoding is “61”. Since the code length is 3 bits, it removes the codes composed of 3 bits from the bit string for 3 and the updated bit string of “010001111xxxx” is obtained.

Next, the processor 2000 similarly searches the first table 13 using first 6 bits of the bit string as an address. Herein, it searches the first table 13 using “010001” as an address. The address applies to Line 2 as shown in FIG. 14. Therefore, after data of the Line 2 is transferred from the main memory 1000 to the cache memory 3100, the processor 2000 tries to access the data.

However, there is now no space in the cache memory. Thus, in the case where there is no data necessary for the data filled up the cache memory, that is, where cache miss is occurred, the control unit 3200 needs to transfer data of the Line 2 to a space generated by the cache miss by writing data of one of Lines stored in the cache memory 3100 back into the main memory 10.

When such cache miss is occurred, the line which is accessed most recently is generally written back. In this case, the control unit 3200 writes back the Line 3 (ref. FIG. 9), and transfers data of the Line 2 therein (ref. FIG. 10). After that, the processor 2000 accesses data of the Line 2 and finds that the code length is 4 bits and the result of decoding is “10”. Since the code length is 4 bits, the processor 2000 removes the codes composed of 4 bits from the bit string and the updated bit string of “01111xxxx” is then obtained.

Next, the processor 2000 similarly searches the first table 13 using first 6 bits of the bit string as an address. Herein, it searches the first table 13 using “01111x” as the address. The address applies to Line 3 as shown in FIG. 14. Therefore, after transferring the data of the Line 3 from the main memory 1000 to the cache memory 3100, the processor 2000 tries to access the data. However, there is now no space in the cache memory. Therefore, the control unit 3200 writes data of one of lines stored in the cache memory 3100 back into the main memory 1000 and transfers the data of the Line 3 to space generated thereby.

When such cache miss is occurred, the Line which is accessed most recently by an LRU method is generally written back. In this case, the control unit 3200 writes back the Line 6 (ref. FIG. 11) and transfers the data of Line 3 therein (ref. FIG. 12). After that, the processor 2000 accesses data of the Line 3 and obtains that the code length is 5 bits and the result of decoding is “16”.

In the above procedure, it is explained that the data of Line 3 and the data of Line 6 are written back from the main memory 1000 to the cache memory 3100. In the procedure of the present operation, the values of data of the Line 3 and Line 6 are not changed while they are stored in the cache memory. That is, the value in the cache memory and the value in the main memory 1000 are the same. Therefore, there is no operation of writing back in many of conventional method of controlling cache memory. Instead, following processing is performed: that the data of Line 1 are written over the cache memory 3100 in which the data of Line 3 are stored, or that the data of Line 3 are written over the cache memory 3100 in which the data of Line 6 are stored.

However, as is clear from the procedure, a target to be replaced is determined by the LRU method so that there is a problem of causing frequent cache miss. Such frequency of cache miss causes plural data transfers (twice) such as Line 3 and the like between the main memory 1000 and the cache memory 3100. It requires a large amount of time for transferring data and increases power consumption.

Such problems are not limited to the case of decoding, it can be said in general for the signal processing apparatus which accesses first and second memory areas via a cache memory and processes a signal by reading data in the first and second memory areas.

### SUMMARY OF THE INVENTION

Considering the conventional problems, it is an object of the present invention to provide a signal processing apparatus using a cache memory, which can reduce the amount of cache miss, data transfer time and the amount of data transfers.

By the way, the present inventor analyzed the conventional technology using a cache memory and found that, in decoding, an access frequency to the first table 13 is 85 percent and an access frequency to the second table 14 is 15 percent. Despite, an algorithm which remains data of the second table in a cache memory by the LRU method is conventionally adapted so that he found a replacement algorithm is inappropriate and came up with the idea of this invention.

Therefore, in order to achieve the objective, a signal processing apparatus according to the present invention is a signal processing apparatus which performs signal processing using data in first and second memory areas, said signal processing apparatus comprising: a cache memory for temporarily holding the data; an access unit operable to read out the data by accessing at least one of the first and second memory areas via said cache memory; and a control unit operable to allocate a space in said cache memory in the case where there is a lack of the space for temporarily holding the data in said cache memory, wherein said control unit is operable to allocate the space into which the data in the first memory area is stored preferentially to the data in the second memory area.

With the structure, the replacement algorithm becomes appropriate by storing data with high access frequency in the first memory area. Accordingly, a signal processing apparatus which reduces the cash miss, time of data transfer and the amount of data transfer in the signal processing apparatus using the cache memory can be provided.

Also, on the signal processing apparatus according to the present invention, the signal processing apparatus further comprises an attribute storage unit operable to hold an intensity attribute indicating that the first memory area has a stronger data-persistent intensity than the second memory area, wherein said control unit is operable to determine data to be stored in said cache memory in accordance with the intensity attribute stored in said attribute storage unit.

Consequently, the replacement algorithm is surely appropriate so that the data area in the cache memory assigned to the data in the second memory area can be limited to the minimum.

Further, in the signal processing apparatus according to the present invention, said access unit accesses i) the first memory area after transferring the data in the first memory area to said cache memory and ii) the second memory area without transferring the data in the second memory area to said cache memory.

Consequently, the replacement algorithm is surely appropriate so that the data area in the cash memory assigned to the data in the second memory area is discarded and the cache memory data area is all assigned to the data in the first memory area.

Further, in the signal processing apparatus according to the present invention, the first memory area holds data which is more frequently accessed than in the second memory area.

Consequently, the replacement algorithm can be surely appropriate.

Furthermore, in the signal processing apparatus according to the present invention, the first and second memory areas respectively have first and second tables indicating conversion rules for converting input data in accordance with a predetermined rule, and said control unit is operable to allocate the space so that the data in the second table is discarded from said cache memory preferentially to the data in the first table.

Consequently, the replacement algorithm can be surely appropriate by storing the first table with access frequency is high in the first memory area. Accordingly, a signal processing apparatus which converts the input data in accordance with a certain rule while reducing cache misses, time of data transfers and the amount of data transfers in the signal processing apparatus using the cache memory.

Also in the signal processing apparatus according to the present invention, the signal processing apparatus further comprises an attribute storage unit operable to hold an intensity attribute indicating that the first table has a stronger data-persistent intensity than the second table, wherein said control unit is operable to determine data to be discarded from said cache memory in accordance with the intensity attribute stored in said attribute storage unit.

Consequently, the replacement algorithm is surely appropriate by storing the first table with high access frequency in the first memory area so that the data area in the cache memory assigned to the data in the second memory area can be the minimum.

Furthermore, in the signal processing apparatus according to the present invention, said signal processing apparatus decodes a Huffman code that is input data, a longest code length of the Huffman code is N bits, the first table is a table for decoding coded data of n bits or smaller, where n is an integer that is 1 or greater and smaller than N, and the second table is a table for decoding coded data that is longer than n bits.

Consequently, the replacement algorithm is surely appropriate by storing the first table for Huffman code decoding with short code length and high access frequency in the first memory area so that the data area in the cache memory assigned to the data in the second memory area can be the minimum.

Note that, the present invention can be embodied not only as such signal processing apparatus but also signal processing method including the characteristic units included in the signal processing apparatus as steps, and as a program causing a computer to execute those steps. Also, not to mention that such program can be distributed via a recording medium such as a CD-ROM and the like and a transmission medium such as the Internet.

As is clear from the explanation in the above, according to the signal processing apparatus by the present invention, the replacement algorithm become appropriate by storing the data which is more frequently accessed in the first memory area so that a signal processing apparatus which reduces cache misses, time of data transfers and the amount of data transfers can be provided for the signal processing apparatus using the cache memory.

Accordingly, the present invention allows signal processing which causes less cache misses, time of data transfers and the amount of data transfers so that practical value of the present invention in is very high today when a computer such as a multifunctional cell phone has been widely available. As further information about technical background to this application, the disclosure of Japanese Patent Application No. 2004-035429 filed on Feb. 12, 2004 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing a Huffman code book 8 on a MPEG-AAC standard.

FIG. 2A is a diagram showing a first table 5000 for performing the Huffman decoding in high speed.

FIG. 2B is a diagram showing a second table 6000 for performing the Huffman decoding in high speed.

FIG. 3 is a diagram showing a relationship of a cache memory, a main memory and a processor.

FIG. 4 is a schematic diagram in the case where the Huffman decoding is performed using a conventional cache memory.

FIG. 5 is a diagram showing a flow of data stored in the cache memory by the conventional technology.

FIG. 6 is a diagram showing a flow of data stored in the cache memory by the conventional technology.

FIG. 7 is a diagram showing a flow of data stored in the cache memory by the conventional technology.

FIG. 8 is a diagram showing a flow of data stored in the cache memory by the conventional technology.

FIG. 9 is a diagram showing a flow of data stored in the cache memory by the conventional technology.

FIG. 10 is a diagram showing a flow of data stored in the cache memory by the conventional technology.

FIG. 11 is a diagram showing a flow of data stored in the cache memory by the conventional technology.

FIG. 12 is a diagram showing a flow of data stored in the cache memory by the conventional technology.

FIG. 13 is a diagram showing a structure of a signal processing apparatus 1 according to a first embodiment of the present invention.

FIG. 14 is a diagram showing an example of details of a first table 13.

FIG. 15 is a diagram showing an example of details of a second table 14.

FIG. 16 is a diagram showing an example of details of data stored in an attribute storage unit 52.

FIG. 17 is a block diagram showing an example of a structure of a cache memory device 30 shown in FIG. 13.

FIG. 18 is a diagram showing a detailed bit structure of a cache entry.

FIG. 19 is a block diagram showing a structure of a cache control unit 42.

FIG. 20 is a block diagram showing an example of a structure of a W flag set unit.

FIG. 21A is a diagram showing an example of an instruction to write a command in a command register.

FIG. 21B is a diagram showing an example of the command.

FIG. 21C is a diagram showing an example of an instruction to write a start address in a start address register.

FIG. 21D is a diagram showing an example of an instruction to write a size in a size register.

FIG. 22 is an illustration of a start aligner and an end aligner.

FIG. 23 is a flowchart showing a W flag set processing by a flag rewrite unit.

FIG. 24 is a flowchart showing a replace processing by a replace unit.

FIG. 25 is a diagram showing a flow of data stored in the cache memory.

FIG. 26 is a diagram showing a flow of data stored in the cache memory.

FIG. 27 is a diagram showing a flow of data stored in the cache memory.

FIG. 28 is a diagram showing a flow of data stored in the cache memory.

FIG. 29 is a diagram showing a flow of data stored in the cache memory.

FIG. 30 is a diagram showing a flow of data stored in the cache memory.

FIG. 31 a diagram showing a flow of data stored in the cache memory.

FIG. 32 is a block diagram showing a structure of a signal processing apparatus 2 according to a second embodiment of the present invention.

FIG. 33 is a diagram showing an example of details of attribute data stored in the attribute storage unit 64.

### DESCRIPTION OF THE PREFERRED EMBODIMENTS

Hereafter, it is explained about a signal processing apparatus according to embodiments of the present invention with reference to drawings.

<Overall Structure>

### First Embodiment

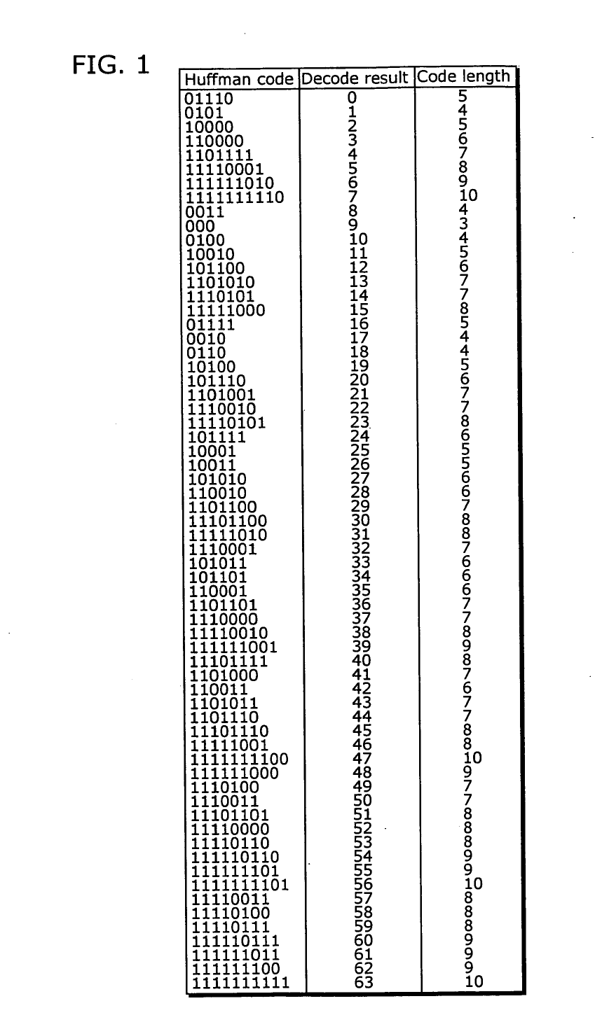

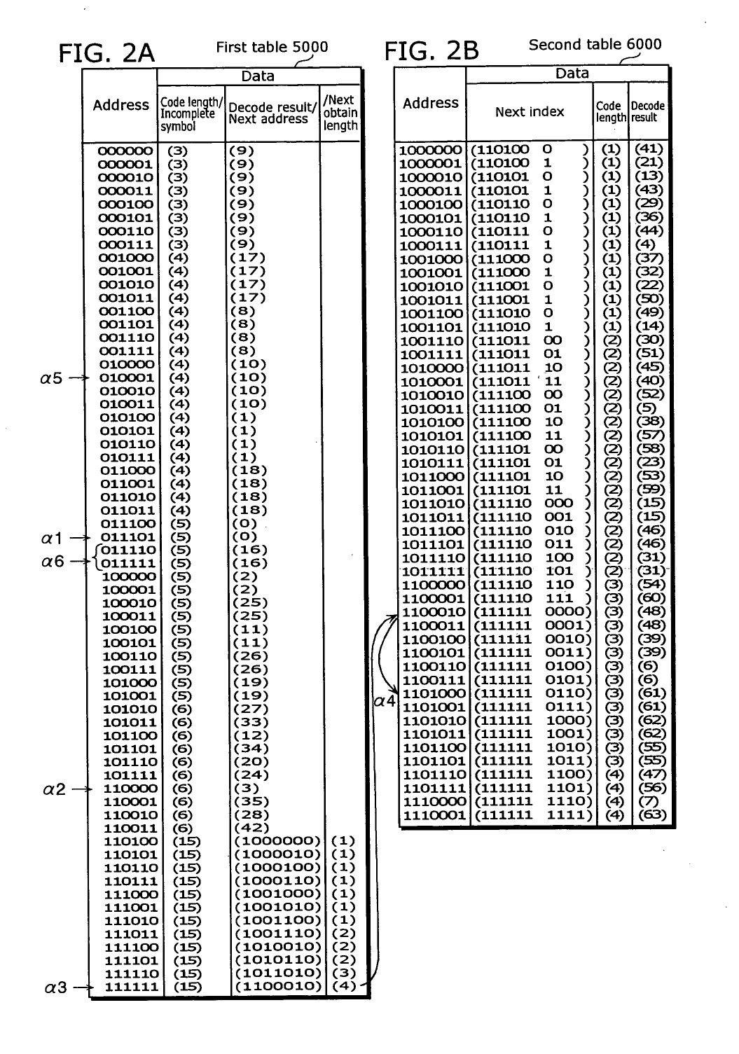

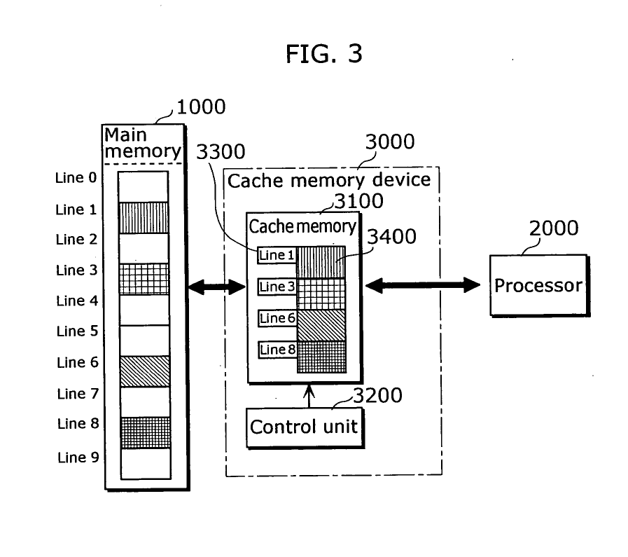

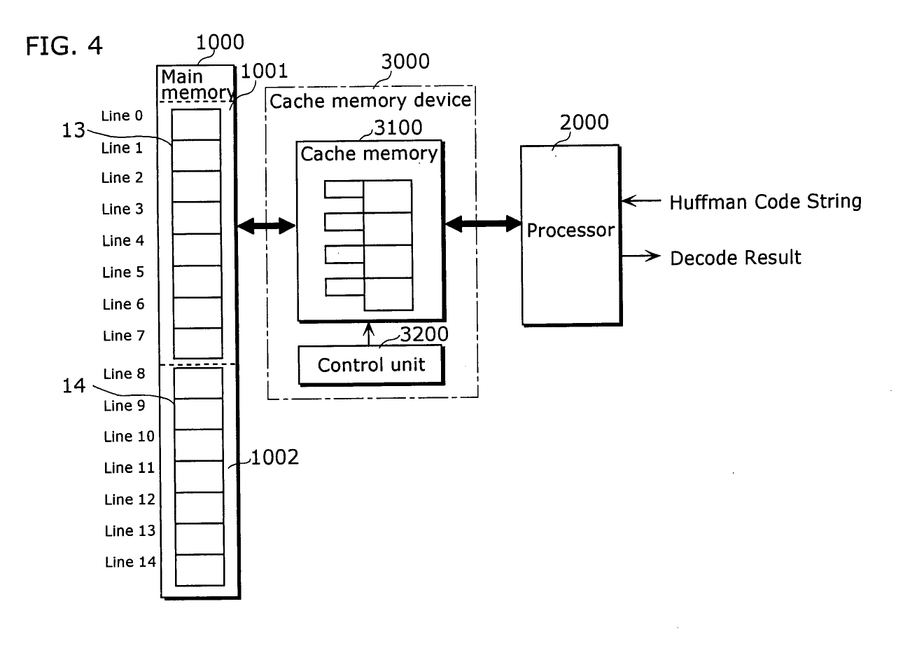

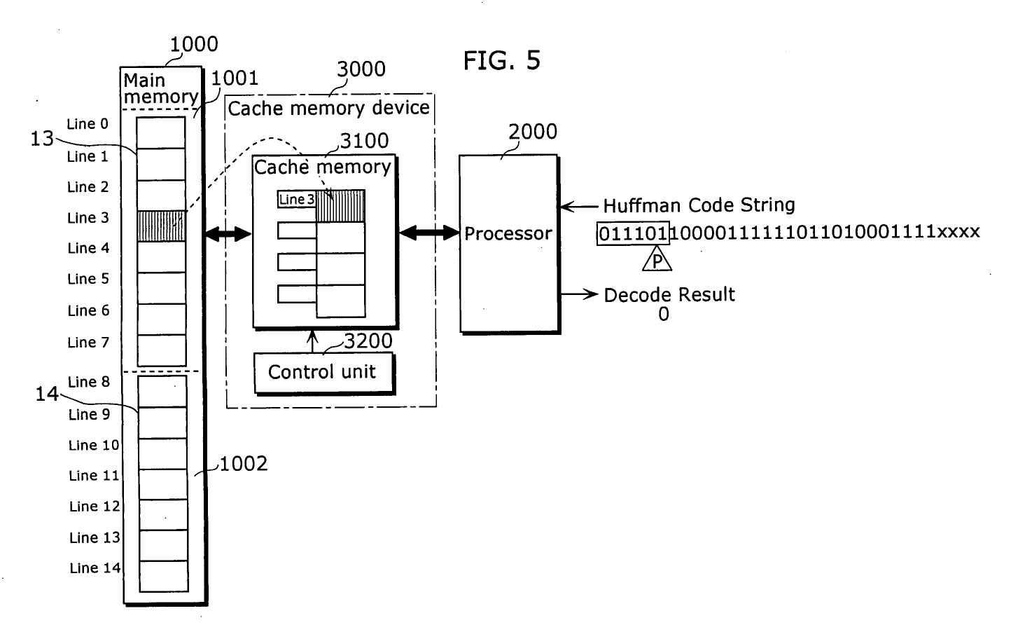

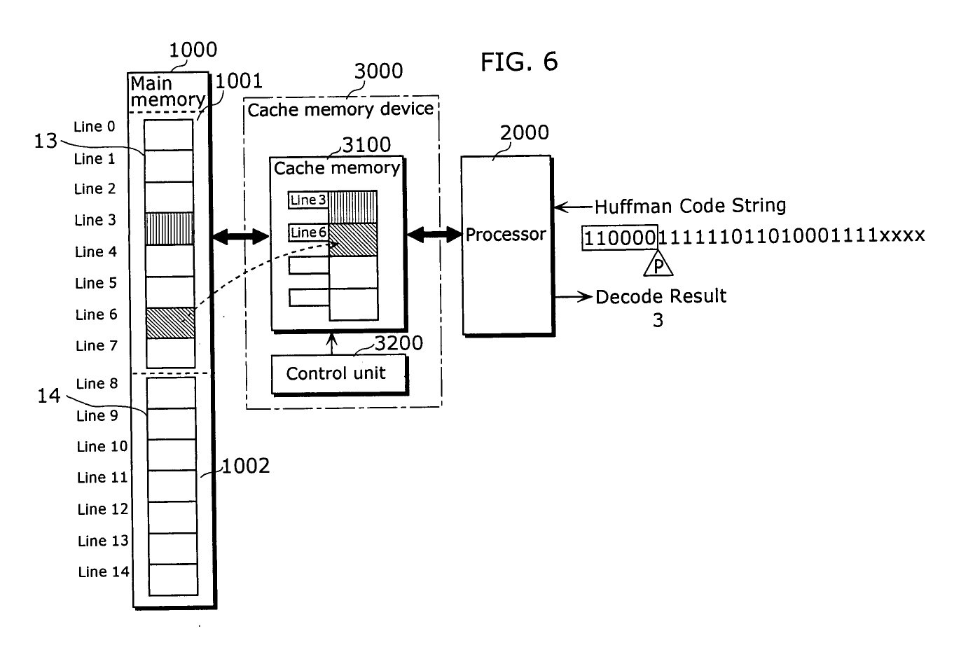

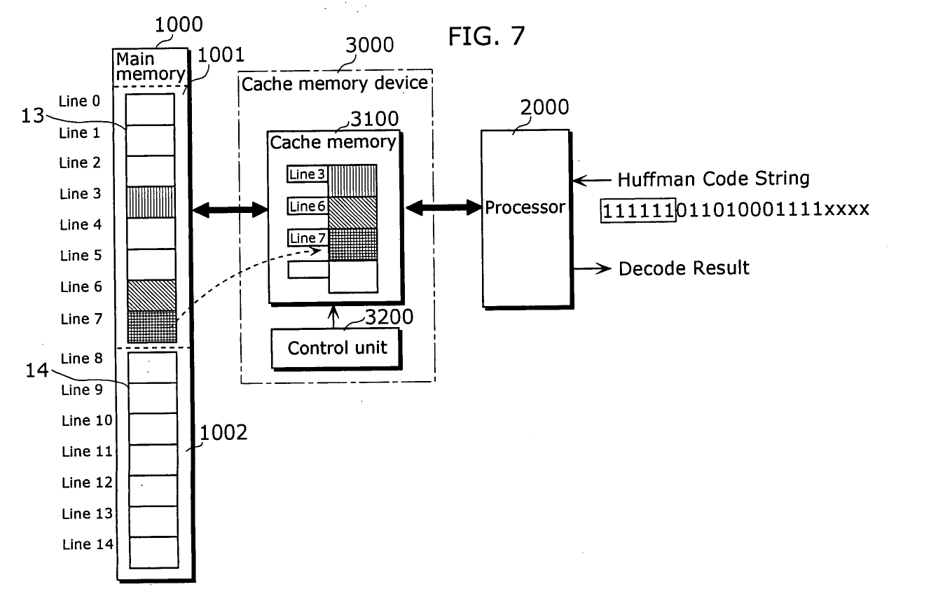

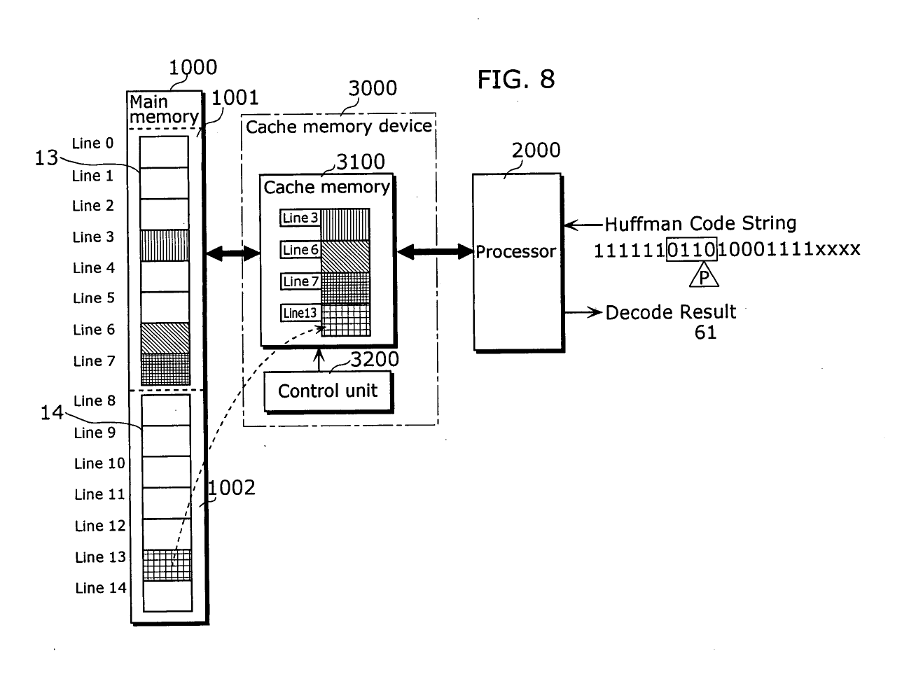

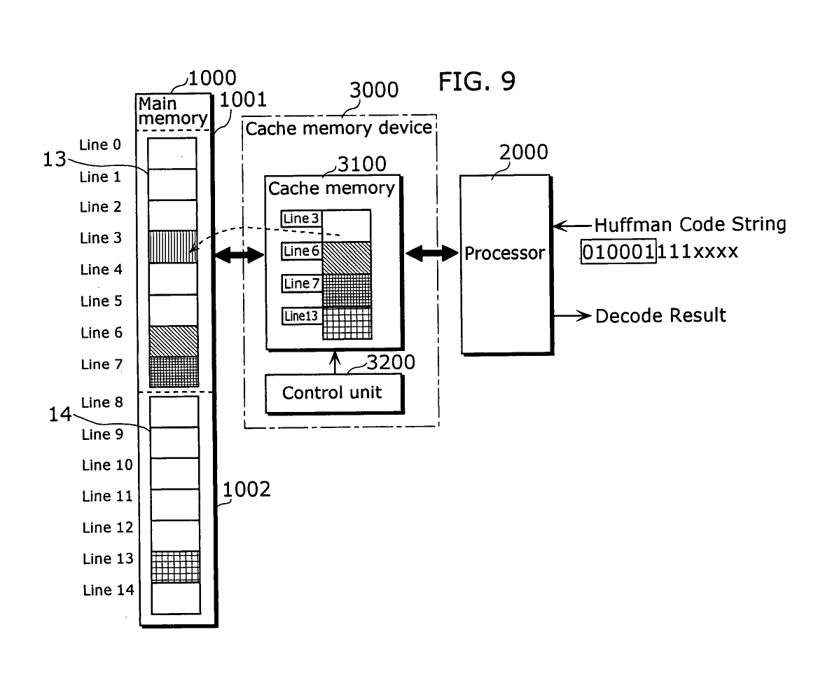

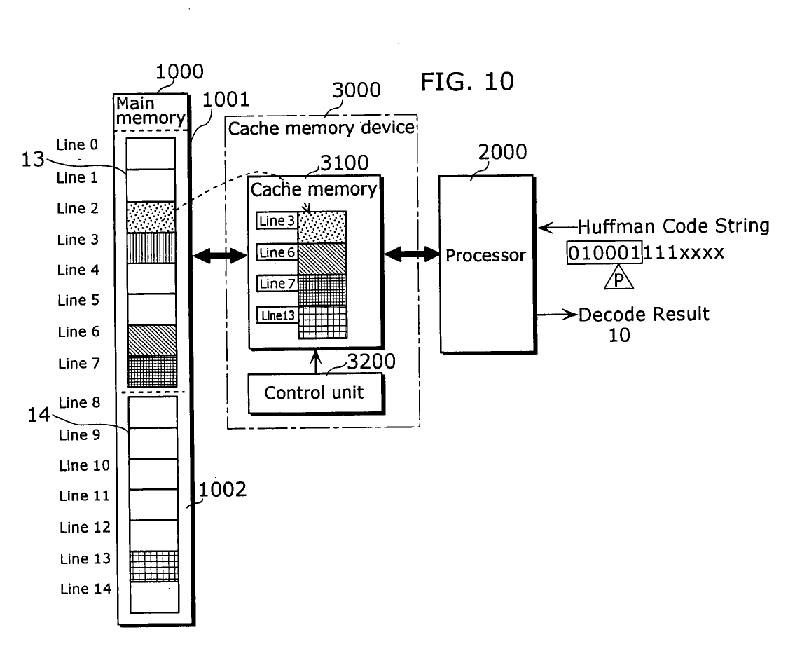

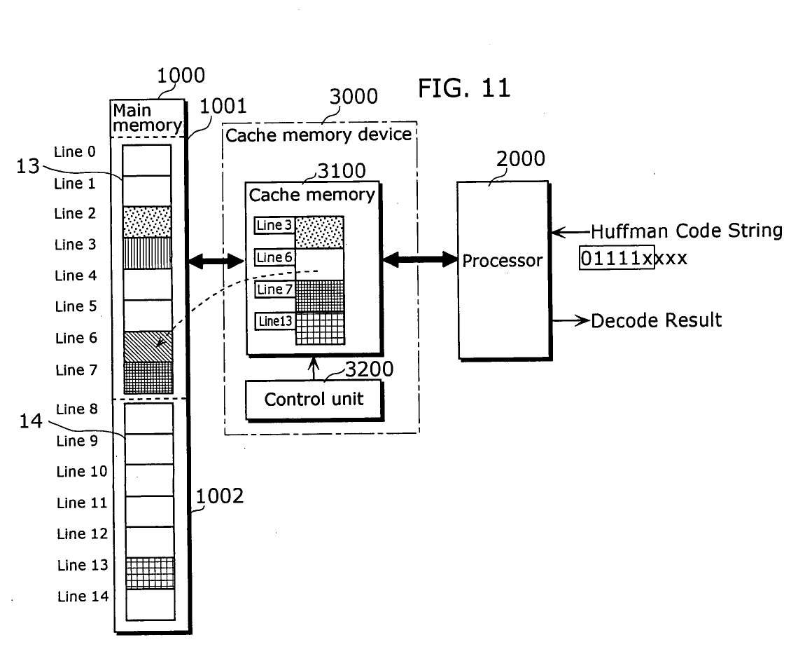

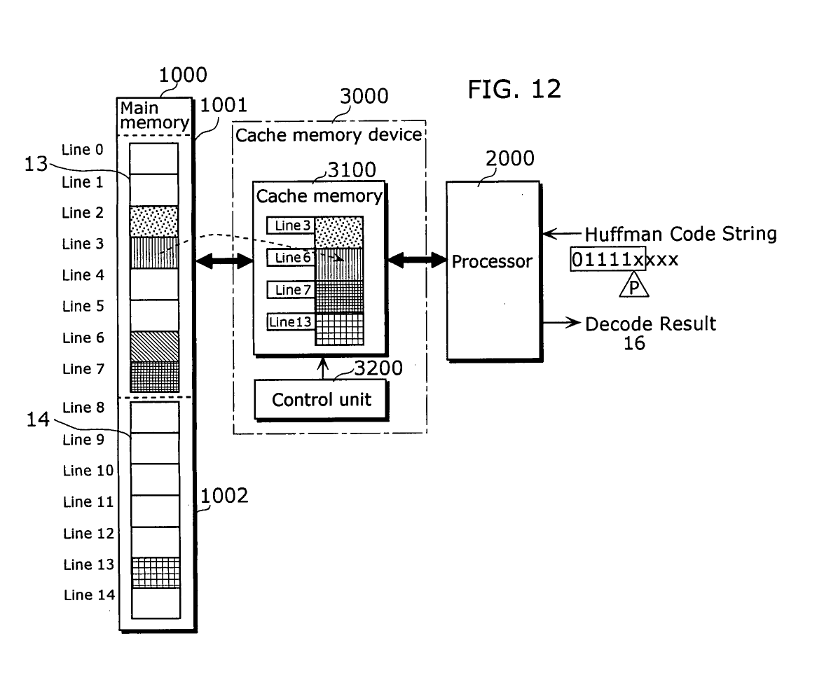

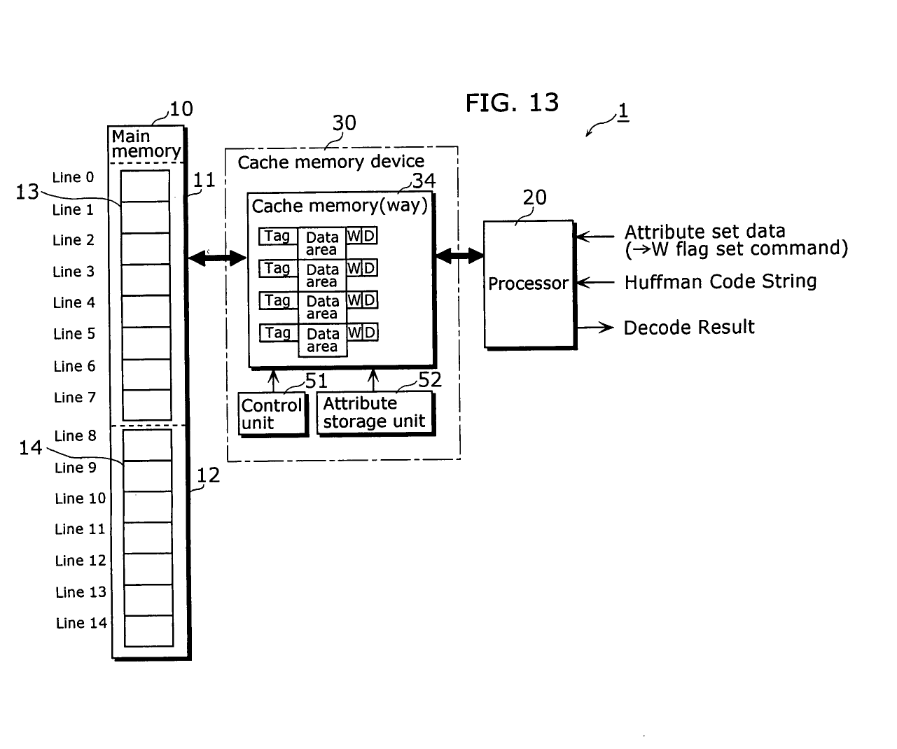

FIG. 13 is a block diagram showing an overall structure of a signal processing apparatus according to the first embodiment of the present invention. Note that FIG. 13 shows a case where the signal processing apparatus 1 is functioned as a decoder which decodes a bit string which is encoded into a Huffman code using a Huffman code book (e.g. 8) on the MPEG-AAC standard shown in FIG. 1.

As shown in FIG. 13, the signal processing apparatus 1 has a main memory 10, a processor 20 as an access unit, a cache memory device 30 and the like.

The main memory 10 is formed of DRAM and the like. It stores respectively a first table 13 for decoding in a first memory area 11 for one step and a second table 14 for decoding in a second memory area 12 for two steps.

The cache memory device 30 is formed of a SRAM and the like and it has a cache memory 34 including a tag area, a data area, a weak flag W indicating an intensity attribute which is a data-persistency ratio of remaining in the data area, a dirty flag D indicating whether or not write-back is necessary; a control unit 51 which controls replacing; an attribute storage unit 52 which stores data (attribute data) for setting a ratio of remaining in the cache memory 34. In a premise of replace control for replacing a cash entry whose access number is old by so-called LRU method, the cache memory device 30 changes, in contradiction to the access order, order data indicating an access order for determining a replace target, and removes the cache entry holding data whose access frequency is low from the cache memory as a target to be replaced. In specific, it adds the weak flag W indicating that the access order is the oldest to the cache entry and indirectly changes the order data. Consequently, a complicated circuit which directly changes the order data is unnecessary.

For starting decoding, the processor 20 writes the first table 13 and the second table 14 respectively into the first memory area 11 and the second memory area 12, and sets, based on predetermined attribute value set data, an intensity attribute in the attribute storage unit 52. The processor 20 then accesses the cache memory using the Huffman code string to be decoded as an address so as to obtain the result of decoding.

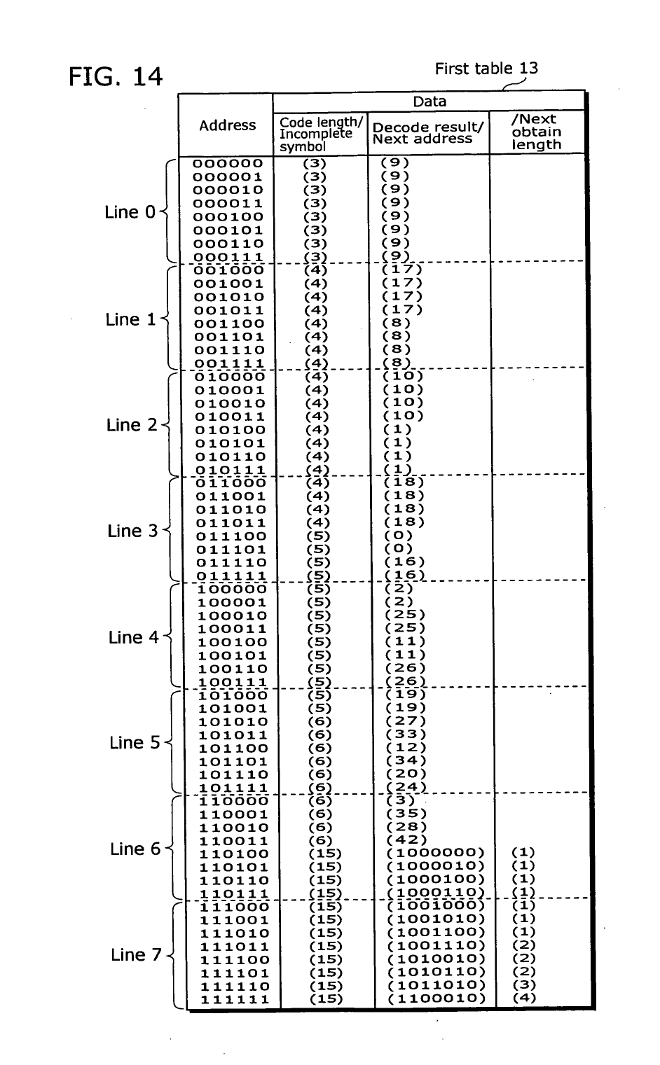

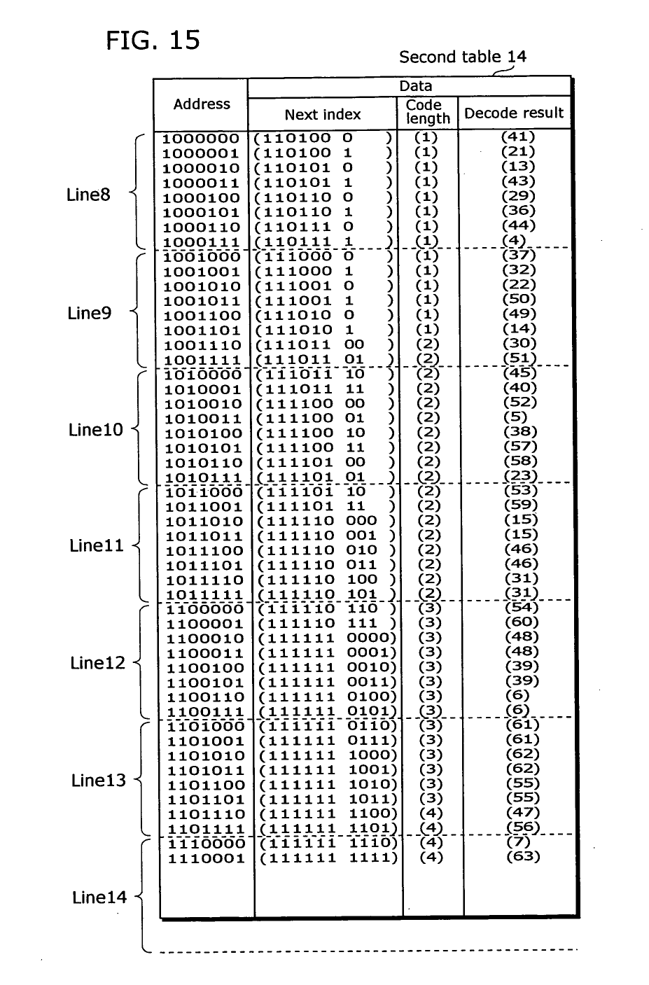

FIG. 14 is a diagram showing a structure of the first table 13 and FIG. 15 is a diagram showing a structure of the second table 14.

The first table 13 and the second table 14 respectively indicate conversion rules for converting input data according to a predetermined rule. In specific, they correspond to the Huffman code book used for encoding and respectively mapped in the first memory area 11 and the second memory area 12.

The first table 13 is a table for decoding a Huffman code, which can be included in the predetermined bit number data readout from a bit stream, with relatively short code length having a number of bits as many as the predetermined number (6 bits) or less into the result of decoding. Also, the second table 14 is a table for decoding an address pointer obtained by the first table 13 when the decoding is not completed by the short Huffman code, and a Huffman code with a relatively long code length having a number of bits as many as the predetermined number or more number of bits calculated based on the Huffman code with a bit length shown by the next obtainment point. Thus, the relatively short Huffman code and the relatively long Huffman code are decoded by a process using the first table 13 and the second table 14.

As shown in FIG. 14, the first table 13 is made up of a column in which data of code length or incomplete symbol (here indicates “15”) is stored, a column in which the result of decoding or data of next address is stored, and a column in which data of next obtainment length is stored. Note that, for convenience, addresses and line at which these data are stored are shown on the left side of the first table 13.

As shown in FIG. 15, the second table 14 is made up of a column in which data of code length is stored and a column in which data of the result of decoding is stored. For convenience, addresses and lines at which these data are stored are shown on the left side of the first table 13.

Here, in the Huffman encoding, shorter Huffman code is assigned to an input value which is more frequently appeared in general and longer Huffman code is assigned to the input value which is less frequently appeared. Accordingly, in the decoding, it is said that access frequency of the first table 13 is higher than that of the second table 14.

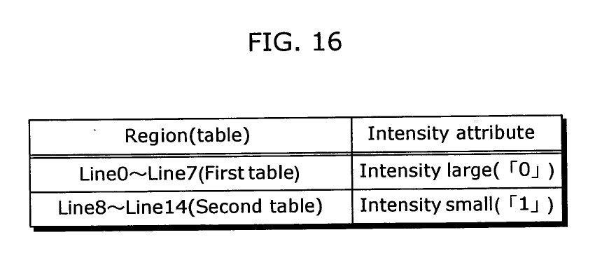

FIG. 16 is a diagram showing an example of details of attribute data stored in an attribute storage unit 52.

Herein, it is indicated that the intensity from Line 0 to Line 7 that are in the first table 13 is high (weak flag W is “0”) and the intensity from Line 8 to Line 14 that are in the second table 14 are less (weak flag W is “1”). By setting such intensity attribute, appropriate replacement and algorithm are exerted reducing cache miss.

<Specific Structure of Cache Memory Device>

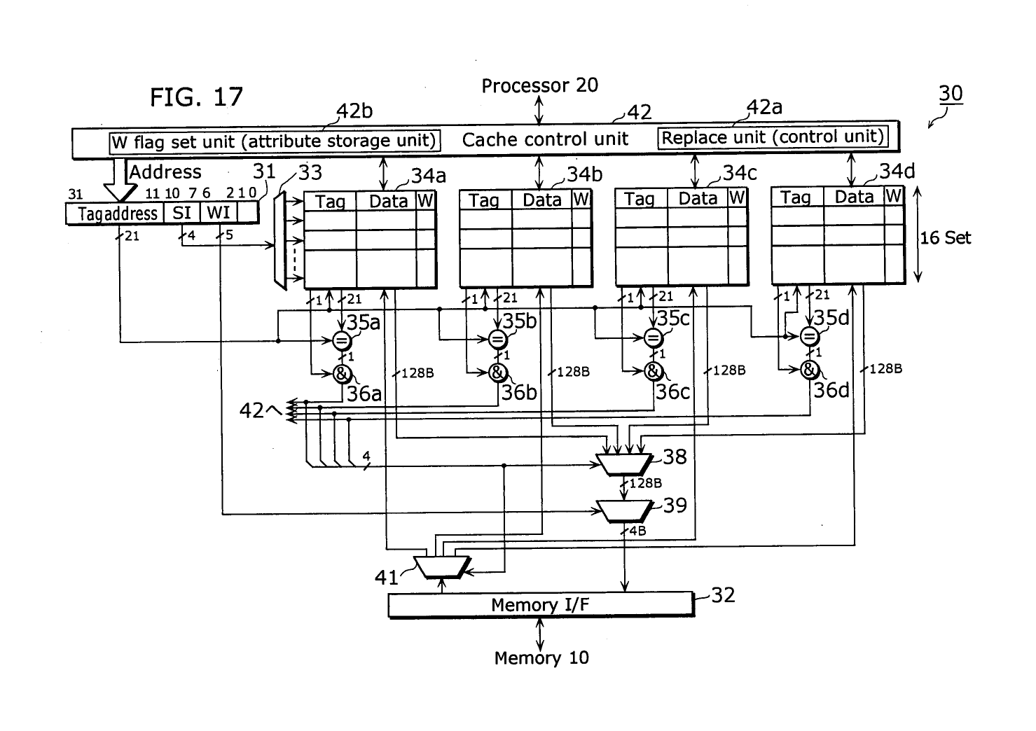

FIG. 17 is a block diagram showing an example of a specific structure of the cache memory device 30. Here, as a specific example of the cache memory device 30, it is explained about a structure in the case where the present invention is applied to a cache memory of 4 way set associative method.

As shown in FIG. 17, the cache memory device 30 has an address register 31, a memory I/F 32, a decoder 33, 4 ways 34a to 34d (hereafter also referred to as “way 0 to 3”), four comparators 35a to 35d, four AND circuits 36a to 36d, a selector 38, a selector 39, a demultiplexer 41 and a cache control unit 42. The cache control unit 42 has a replace unit 42a and a W flag set unit 42b.

Here, the replace unit 42a in a specific example of the cache memory device 30 applies to the control unit 51 in FIG. 13, and the W flag set unit 42b applies to an attribute storage unit 52 in FIG. 13.

The address register 31 is a register which holds an access address to the main memory 10. The access address is assumed to be 32 bits. As shown in FIG. 17, the access address includes, sequentially from the most significant bit, a tag address of 21 bits, a set index of 4 bits (SI in FIG. 17), and a word index of 5 bits (WI in FIG. 17). Here, the tag address indicates an area (its size is calculated by number of sets multiplied by blocks) in a memory which is mapped by a way. The size of the area is a size determined by an address bit (A10 to A0) which is lower than the tag address, that is, 2 k bytes. This also indicates a size of a way. The set index (SI) indicates one out of plurality of sets across the way 0 to 3. There are 16 sets since the set index is 4 bits. The cache entry which is specified by the tag address and the set index is a unit of replacement, and is called as line data or a line when being stored in a cache memory. The size of the line data is a size determined by an address bit which is lower than the set index, that is, 128 bytes. Counting 1 word as 4 bytes, one line data is 32 words. The word index (WI) indicates one word in a plurality of words forming the line data. The least significant 2 bits (A1, A0) in the address register 31 are ignored when the word is accessed.

The memory I/F 32 is an I/F for accessing to the main memory 10 from the cache memory device 30 such as for loading of data from the main memory 10 to the cache memory device 30, for writing back data from the cache memory device 30 to the main memory 10, and the like.

The decoder 33 decodes 4 bits of the set index and selects one out of 16 sets across 4 ways 0 to 3.

The 4 ways 0 to 3 are 4 ways, each of which has a same structure and has a capacity of 4 multiplied by 2 bytes. Each way has 16 cache entries.

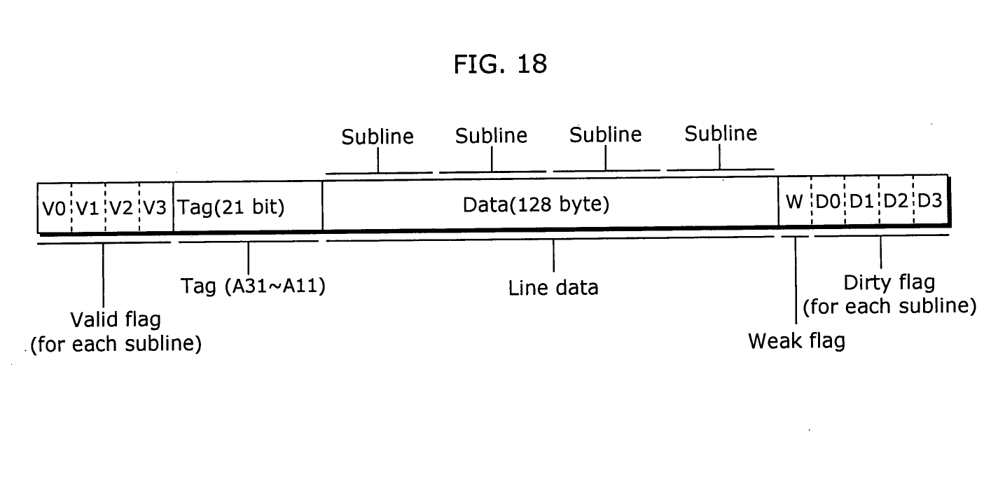

FIG. 18 is a diagram showing a detailed bit structure in one cache entry shown in FIG. 17.

As shown in FIG. 18, one cache entry has valid flags V0 to V3, a tag of 21 bits, a line data of 128 bytes, a weak flag W and dirty flags D0 to D3.

The tag is a copy of a tag address of 21 bits.

The line data is a copy of 128 bytes data in a block specified by the tag address and the set index. It is formed of 4 sub-lines of 32 bytes each.

The valid flags V0 to V3 correspond to the respective 4 sub-lines, showing whether the sub-lines are valid or not.

The weak flag is a flag for defining that the cache entry has the oldest access order. That is, when W=1, it indicates that the processor 20 does not read or write from/to the cache entry any more or that the access frequency is low. Also, when W=1, it indicates that, in the cache memory device 30, the access order concerning the replace control is the oldest. That is, it indicates the weakest cache entry. When W=0, it indicates the opposite.

The dirty flags D0 to D3 correspond to the respective 4 sub-lines and each indicate that whether there is a write-in in the sub-line from the processor 20. That is, even if the cached data is found in the sub-line, the data differs from the data in the main memory 10 because of the write-in. Therefore, it indicates that whether or not it is necessary to write back to the main memory 10.

The comparator 35a compares whether or not a tag address in the address register 31 matches a tag of way 0 among 4 tags included in the set selected by the set index. The same thing can be said for other comparators 35b to 35c except that they correspond respectively to ways 34b to 34d.

The AND circuit 36a compares whether comparison results of the valid flag and the comparators 35a match or not. When the result of comparison is “1”, it indicates that there is a line data corresponding to the tag address and the set index in the address register 31, that is, there is a hit in the way 0. When the result of comparison is “0”, it indicates that there is a cache miss. As for the AND circuits 36b to 36d, the same thing can be applied except that they correspond to the respective ways 34b to 34d. The comparison results indicate respectively that there is a hit in ways 1 to 3 and that there is a cache miss in the ways 1 to 3.

The selector 38 selects line data of the hit way from/among line data of ways 0 to 3 in the selected set.

The selector 39 selects one word shown in word index from/among line data of 32 words selected by the selector 38.

The demultiplexer 41, when writing data in a cache entry, outputs writing data to one of the ways 0 to 3. This writing data may be unit of a word.

The cache control unit 42 controls the cache memory device 30 as a whole. In particular, it sets a W flag and controls a replacement according to the W flag.

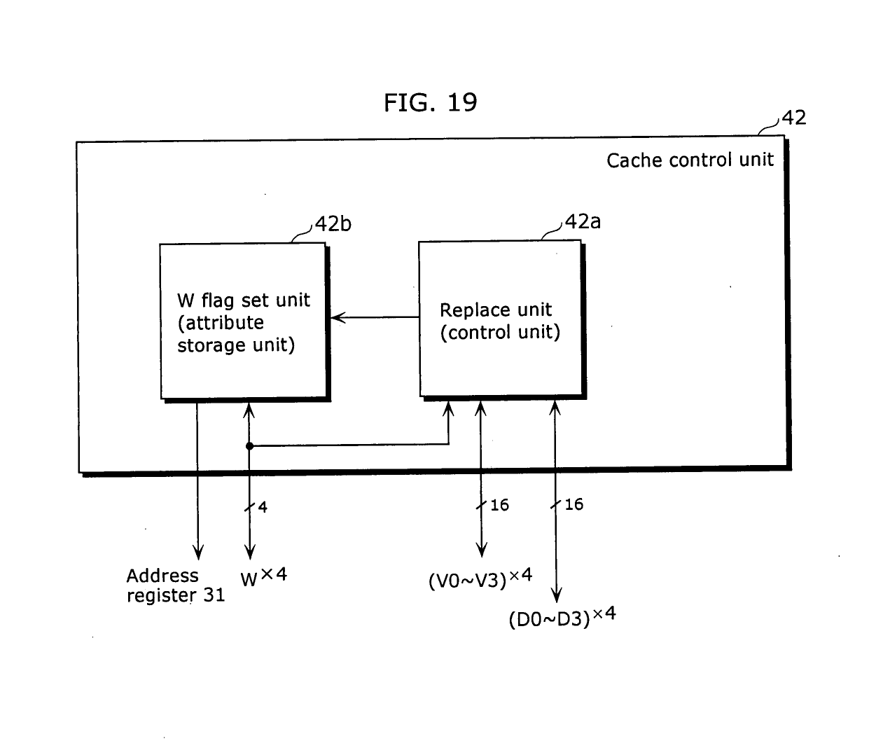

FIG. 19 is a block diagram showing a structure of the cache control unit 42.

The cache control unit 42 has a replace unit 42a which applies to the control unit 51 shown in FIG. 13 and a W flag set unit 42b which applies to an attribute storage unit 52 shown in FIG. 13.

The replace unit 42a, in the case of replacement by a cache miss, if there is a cache entry to which W=1 is assigned, selects said cache entry as a replace target considering it to have the oldest access order, and replaces it.

The W flag set unit 42b sets a weak flag W in accordance with a command from the processor 20. The processor 20 issues, to the cache memory 30, a command for instructing to set a weak flag W to a cache entry which is no longer written and read.

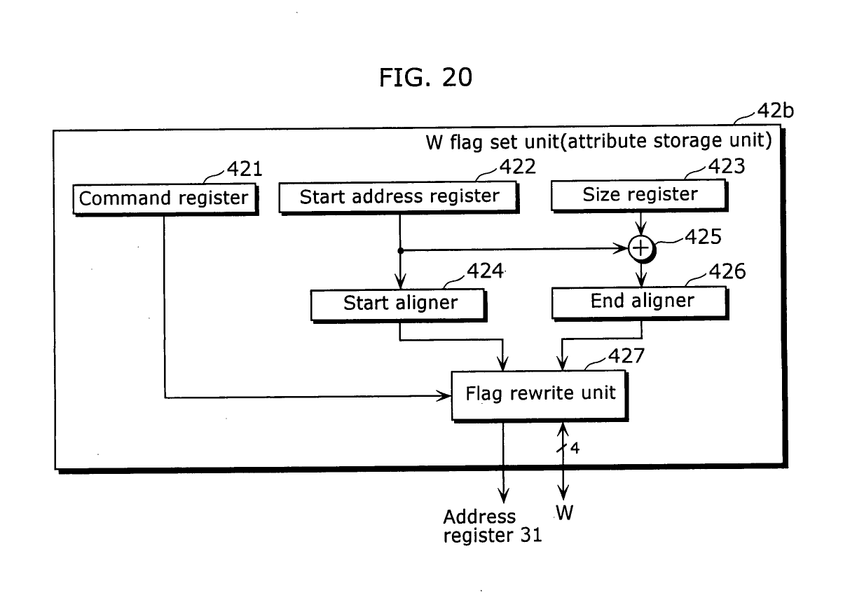

FIG. 20 is a block diagram showing an example of a structure of the W flag set unit 42b.

As shown in FIG. 20, the W flag set unit 42b has a command register 421, a start address register 422, a size register 423, a start aligner 424, an adder 425, an end aligner 426, and a flag rewrite unit 427.

The command register 421 is a register which can be accessed directly from the processor 20 and holds a W flag set command written by the processor 20.

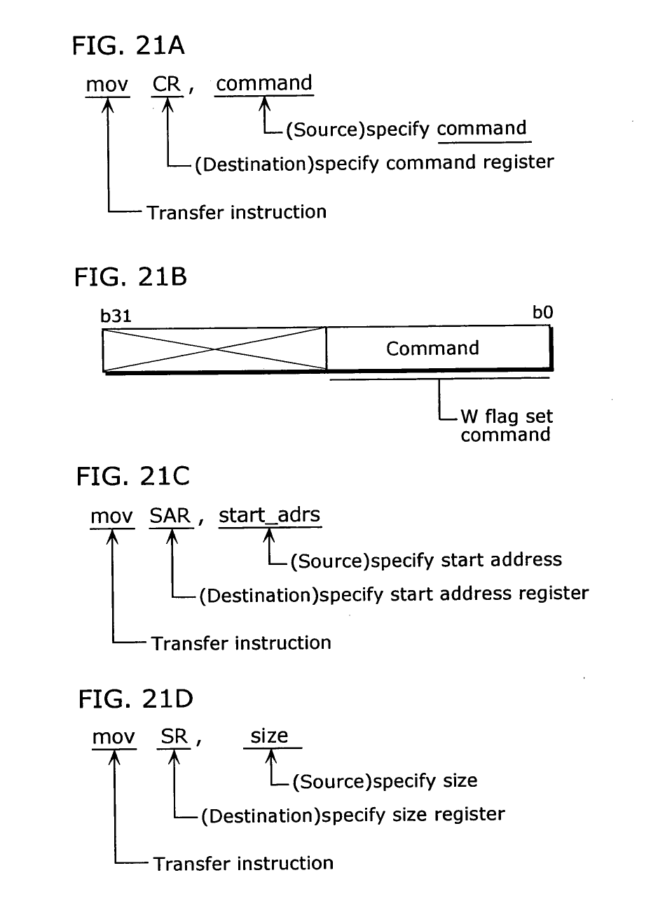

FIG. 21A shows an example of an instruction to write a command in the command register 421.

This instruction is an ordinal transfer instruction (mov instruction). It specifies a command as a source operand and a command register (CR) as a destination operand.

FIG. 21B shows an example of the command. The command is a specific code indicating a W flag set command. The W flag set command is a command for instructing to set a W flag to a cache entry which holds data corresponding to an address range of a size stored in the size register 423 from the start address stored in the start address register 422.

The start address register 422 is a register which can be directly accessed from the processor 20. It holds a start address written by the processor 20. The start address indicates a start position of the address range in which the W flag to be set.

FIG. 21C shows an example of an instruction for writing a start address in the start address register 422. This instruction is also the ordinal transfer instruction (mov instruction) as well as in FIG. 21A.

The size register 423 is a register which can be directly accessed from the processor 20, and holds a size written by the processor 20. The size indicates an address range from the start address.

FIG. 21D shows an example of an instruction for writing a size in the size register 423. This instruction is also the ordinal transfer instruction (mov instruction) as similar in the FIG. 21A. Note that, a unit of the size can be the number of bytes or the number of lines (the number of cache entries) unless the unit is previously determined.

The start aligner 424 aligns the start address on a line boundary. By the alignment, the processor 20 can specify an arbitral address freely from the line size and the line boundary as a start address.

The adder 425 adds the start address stored in the start address register 422 to the size stored in the size register 423. The result of the addition is an end address indicating an end position of the address range. The adder 425 performs an addition as a byte address when the size is specified by the number of bytes, and as a line address when the size is specified by the number of lines.

The end aligner 426 aligns the end address on a line boundary. By the alignment, the processor 20 can specify an arbitral size freely from the line size and the line boundary as said size.

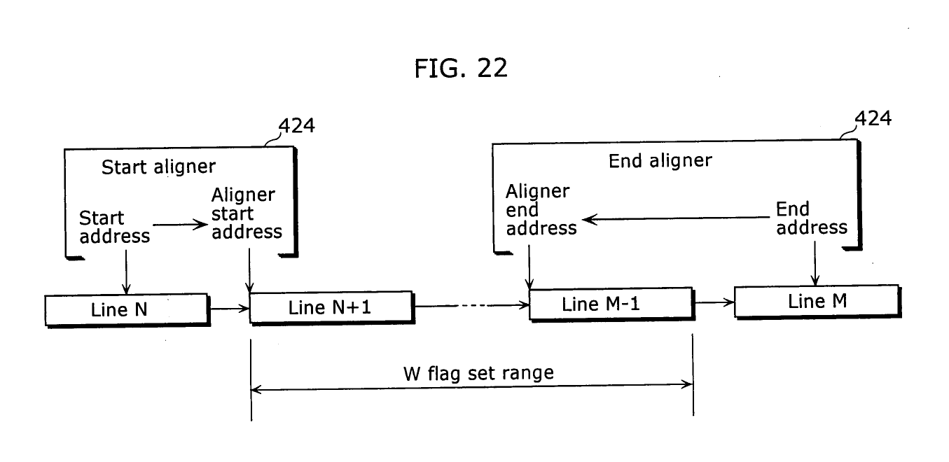

FIG. 22 shows an illustration of the start aligner 424 and the end aligner 426.

In FIG. 22, the start address specified by the processor 20 indicates an arbitral position somewhere on the line N. The start aligner 424 aligns so as to indicate the beginning of the next line (N+1) and outputs the aligned address as the aligned start address. The line indicated by the align start address is called as a start line.

Also, the end address indicates an arbitral position somewhere on the line M. The end aligner 426 aligns so as to indicate the beginning of the immediately preceding line (M−1), and outputs the aligned address as the aligned end address. The line indicated by the aligned end address is called as an end line.

In this case, an F flag is set to each line (cache entry) from the start line (line (N+1)) to the end line (line (M−1)). The reason why the start aligner 424 and the end aligner 426 are aligned inside the address range from the start address to the end address specified by the processor 20 is that there is a possibility of reading and writing from the processor 20 in an area outside the line N and the line M.

The flag rewrite unit 427 sets the W flag to 1 if lines from the line indicated by the align start address to the line indicated by the align end address (in FIG. 22, from the line (N+1) to the line (M−1)) are added as entries to the cache memory device 30.

<W Flag Set Processing>

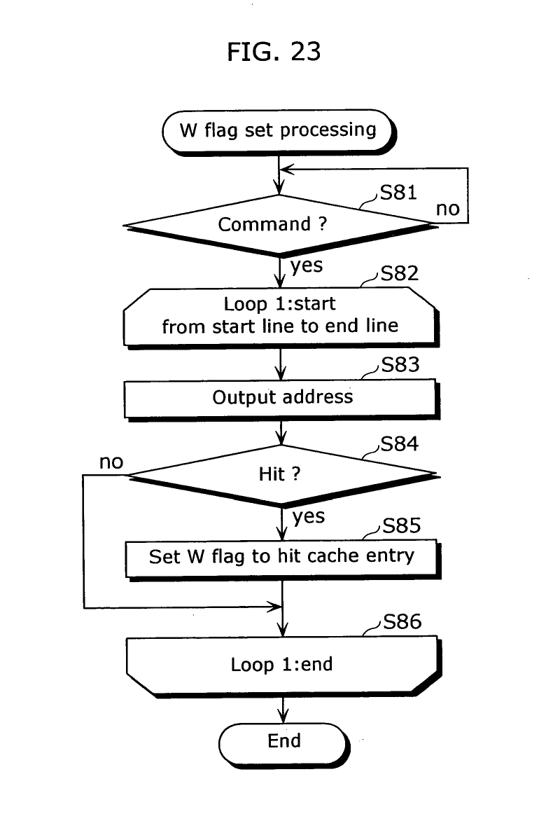

FIG. 23 is a flowchart showing an example of a W flag set processing by the flag rewrite unit 427.

The flag rewrite unit 427 performs processing of a loop 1 (S82 to S86) while sequentially outputting each line address from the start line to the end line in the case where the command register 421 holds a W flag set command. The flag rewrite unit 427 repeats the same processing for each line. The processing for one line is therefore explained in here.

That is, the flag rewrite unit 427 outputs the line address to the address register 31 while the cache memory device 30 is not being accessed by the processor 20 (S83). It then allows the comparators 35a to 35d to compare the tag address of the address register 31 to the tag of the cache entry, and judges whether there is a cache hit (S84). Further, in the case where there is a cache hit, the flag rewrite unit 427 sets the W flag to 1 for the hit cache entry (S85). In the case where there is a cache miss, no processing is performed since there is no entry in the cache memory.

Accordingly, in the case where, for each line from the start line to the end line, the line is added as an entry to the cache memory, the W flag is set to “1”.

<Replace Processing>

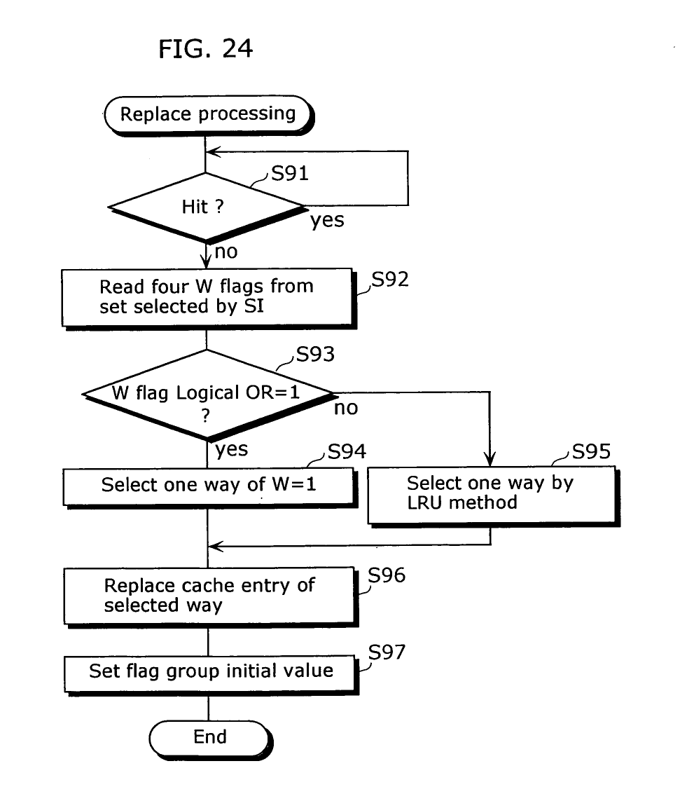

FIG. 24 is a flowchart showing a replace processing in the replace unit 42a.

In FIG. 24, the replace unit 42a, when there is a cache miss at which a memory is accessed (S91), reads out weak flags W for four ways (S92), and judges whether or not a logical OR of the four weak flags is 1 or not, that is, whether there is a way of W=1 (S93). When it is judged that there is a way of W=1, the replace unit 42a considers that the access order of the cache entry is the oldest, and selects one of the ways of W=1 (S94). When there is a plurality of ways, each having a value of W is 1, the replace unit 42a randomly selects one of the ways.

Further, the replace unit 42a replaces a cache entry of the selected way in the set as a target (S96), and initializes the weak flag W of the cache entry to 0 after the replacement (S97). Herein, the valid flag V and the dirty flag D are respectively initialized into 1 and 0.

Thus, when there is no way of W=1, the target to be replaced is selected by a normal LRU method. Also, when there is a way of W=1, the replacement target is considered as the oldest access order of the way W=1 so that the cache entry of the way of W=1 is selected. Consequently, the amount of cache misses caused because of that data of W=1 which is less frequently accessed exist in the cache memory can be reduced.

As explained in the above, according to the cache memory in the first embodiment, the line of weak flag W=1 is a line which is no longer read or written, and is considered to have the oldest access order so that the line is first to be selected as a replacement target. Consequently, an induction of cache misses by the data with low access frequency can be reduced.

Further, the access order is altered by indirectly adding a W flag without directly altering the order data indicating an access order by the conventional LRU method. Therefore, it can be embodied without adding a complicated hardware circuit.

Next, an operation executed by each unit of the signal processing apparatus 1 is explained.

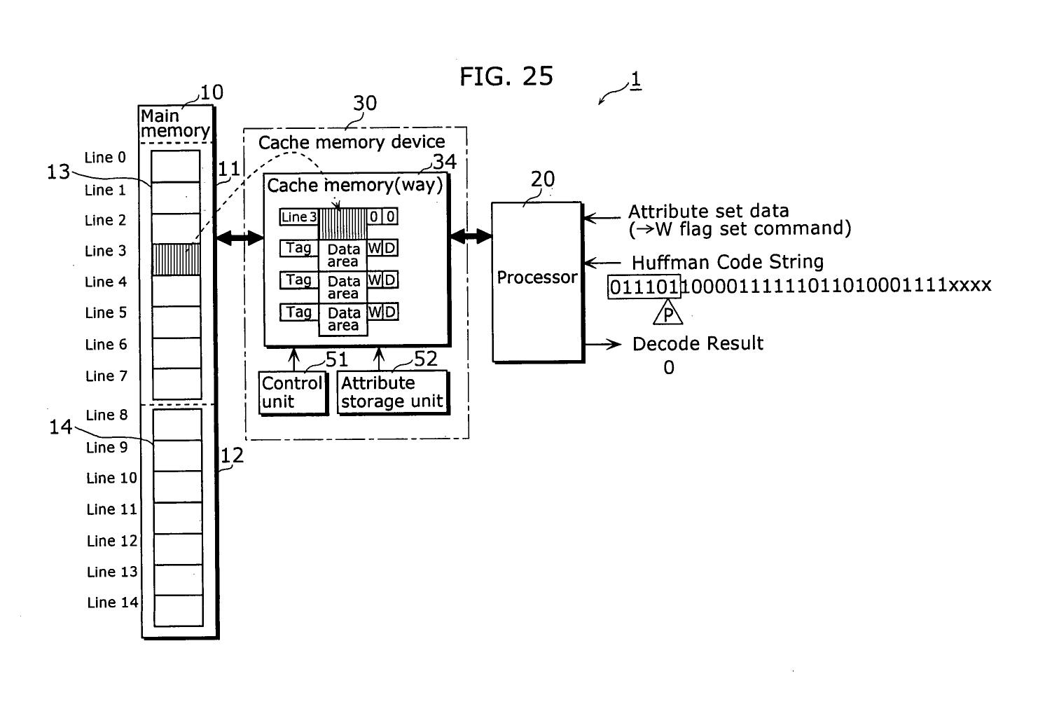

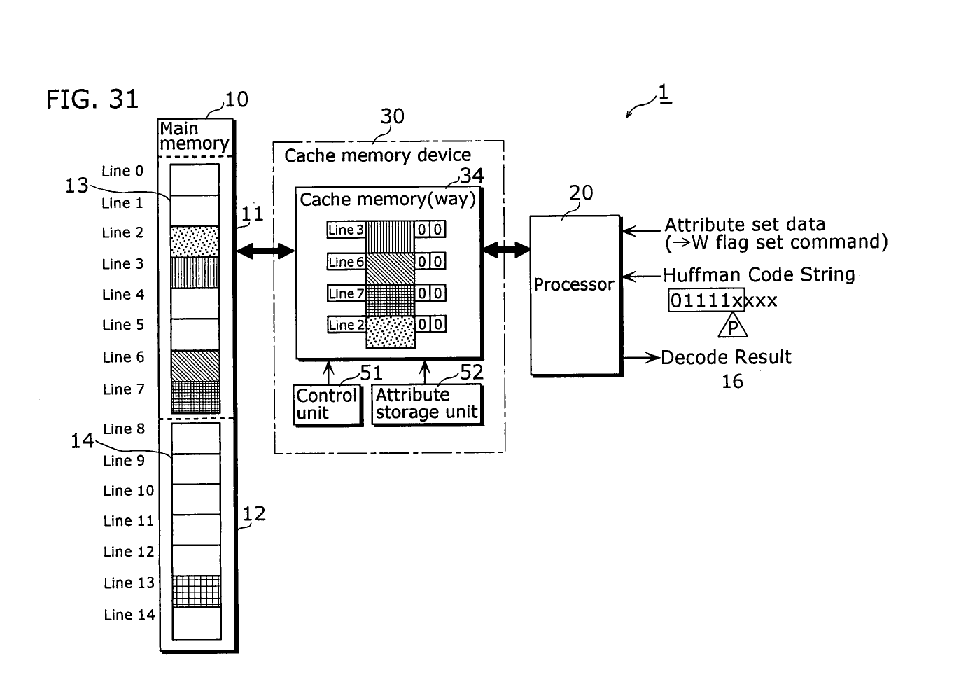

FIGS. 25 to 31 are diagrams showing flows of data stored in the cache memory 34.

In the first embodiment, it is explained using a signal processing apparatus 1 which decodes a code encoded using the Huffman code book 8 on the MPEG-AAC standard shown in FIG. 1 as an example.

Here, in order to make clear the difference of operation with the conventional signal processing apparatus, 4 sets of one way of the cache memory 34 are only used. Also, it is explained that the input bit string continues as “01110110000111111011010001111xxxx” as in the conventional signal processing apparatus.

As shown in FIG. 25, the processor 20 first searches the first table 13 using the first 6 bits “011101” of the bit string as an address. Herein, the address “011101” is found in Line 3 (refer to FIG. 14). After data of the Line 3 is transferred from the main memory 10 to the cache memory 34, the processor 20 accesses the data having the address “011101” and obtains the code length 5 bits and the result of decoding “0”.

Further in detail, the processor 20 outputs, to the cache memory device 30, a lead signal using the first 6 bits “011101” of the bit string as an address. The cache memory device 30 which received the lead signal having “011101” as the address writes the data of the Line 3 in one set of the cache memory 34 by specifying addresses of from the beginning to the end of the Line 3 since there is no data of Line 3 in the cache memory 34. Then, the Line 3 is written in a tag; “0” is written in a W flag; and “0” is written in a dirty flag D. After these writings, the cache memory device 30 outputs, to the processor 20, data at the address “011101”, the code length 5 bits, and the result of decoding “0”.

After obtaining the code length 5 bits and the result of decoding “0”, the processor 20 outputs the result of decoding “0” to a buffer and the like in order to perform signal processing (inverse quantization process, Inverse Modified Discrete Cosine Transform (IMDCT) processing, etc), and removes the codes composed of 5 bits from the bit string since the code length is 5 bits. That is, the obtained point P is shifted to 5 bits. Accordingly, the next bit string becomes “110000111111011010001111xxxx”.

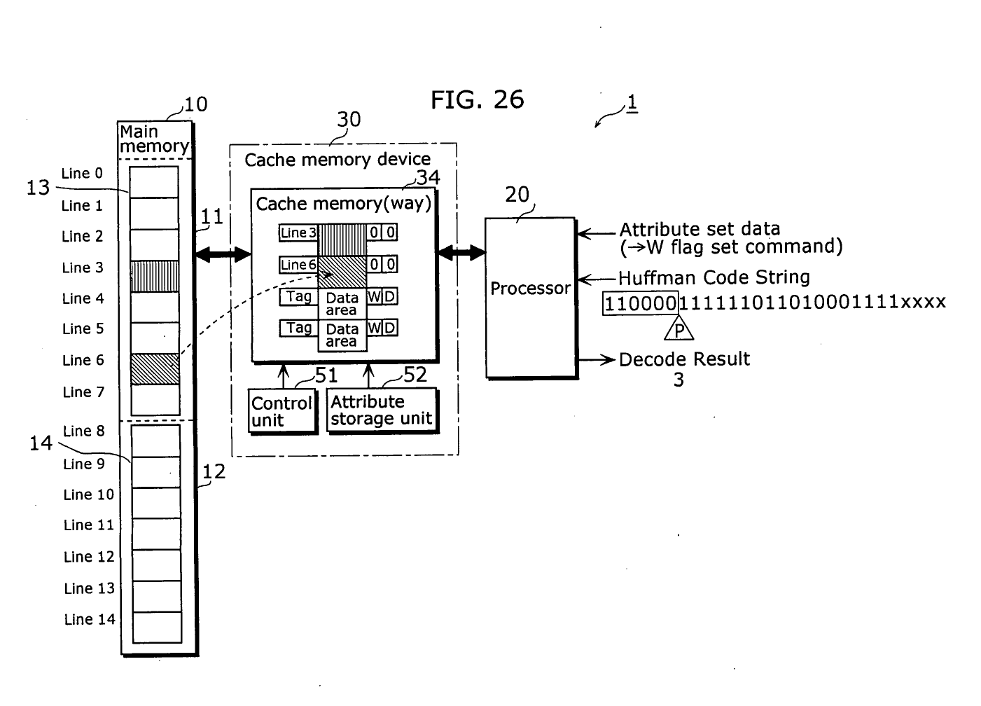

When the next bit string is “110000111111011010001111xxxx”, as shown in FIG. 26, the processor 20 similarly searches the first table 13 using the first 6 bits “110000” of the bit string as an address. Herein, the address “110000” applies to Line 6 (refer to FIG. 14). After transferring the data of the Line 6 from the main memory 10 to the cache memory 34 (FIG. 26), the processor 20 accesses the data at the address “110000”, and obtains the code length 6 bits and the result of decoding “3”.

Here, the Line 6 is written in a tag; “0” is written in a W flag; and “0” is written in a dirty flag D.

The processor 20 then outputs the result of decoding “3”, and removes the codes composed of 6 bits from the bit string since the code length is 6 bits. That is, the obtained point P is shifted to 6 bits. Since the code length is 6 bits, the processor 20 updates the bit string to 6 bits so that the next bit string becomes “111111011010001111xxxx”.

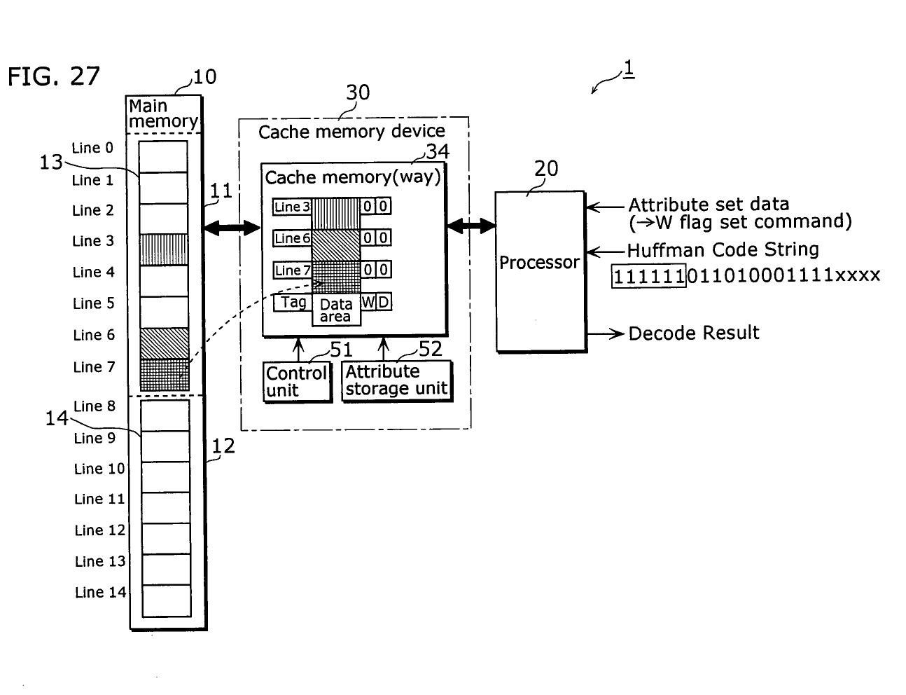

When the next bit string is “111111011010001111xxxx”, as shown in FIG. 27, the processor 20 similarly searches the first table 13 using the first 6 bits “111111” of the bit string as an address. Herein the address “111111” applies to Line 7 (refer to FIG. 14). After the data in the Line 7 is transferred from the main memory 10 to the cache memory 34, the processor 20 accesses the data at the address “111111” and obtains an incomplete symbol “15”, a next address pointer “1100010”, and the number of bits “4” to be read next.

Note that, the Line 7 is written in a tag; “0” is written in a W flag; and “0” is written in a dirty flag D. Here, the obtainment operation of data by the cache memory device 30 is same as in the case described in the above. Therefore, the explanation is omitted in here.

Here, the processor 20 moves a pointer to an address “1100010” in the second table 14 shown in FIG. 15, removes the codes composed of 6 bits from the bit string, and searches the second table 14 using the values of the following 4 bits as an index from the address “1100010”. Herein, the value of the 4 bits is “0110” so that the address to be accessed next “1101000” is obtained by adding “0110” to the address “1100010”.

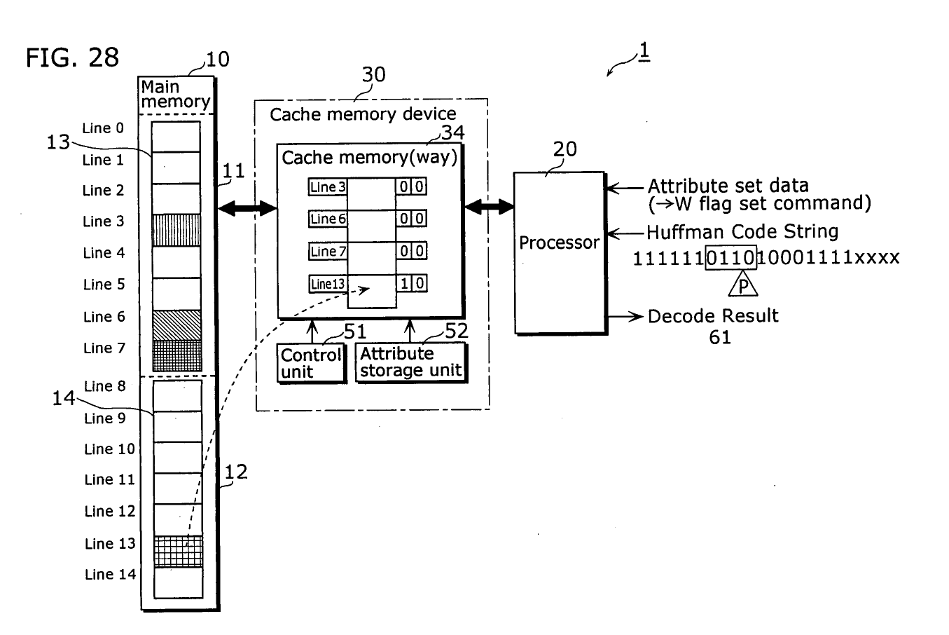

That is, as shown in FIG. 28, the processor 20 obtains the next 4 bits “0110”, adds the following 4 bits “0110” to the previously obtained address “1100010”, and calculates the address “1101000” to be accessed next.

After the calculation, the processor 20 searches the second table 14 using the obtained “1101000” as an address. The address “1101000” is found in Line 13 (refer to FIG. 15). After the data in the Line 13 is transferred from the main memory 10 to the cache memory 34, the processor 20 therefore accesses the data and obtains the code length 3 bits and the result of decoding “61”.

Here, the Line 13 is written in a tag; “1” is written in a W flag; and “0” is written in a dirty flag D.

The processor 20 then outputs the result of decoding “61” and removes the codes composed of 3 bits from the bit string since the code length is 3 bits. That is, the obtained point P is updated to 6+3=9. After moving the obtained point P, the next bit string becomes “01000111xxxx”.

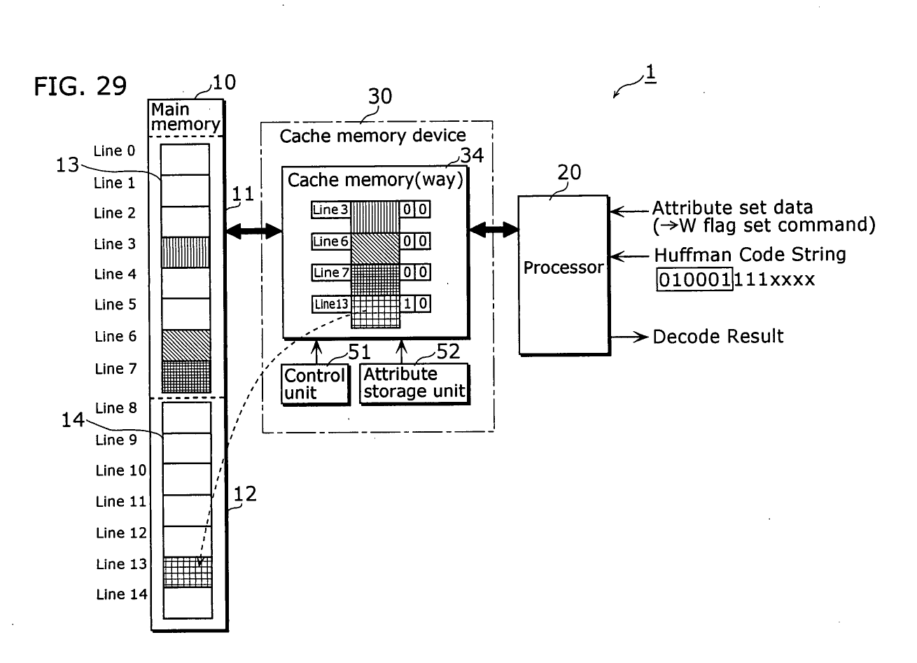

When the next bit string is “010001111xxxx”, as shown in FIG. 29, the processor 20 similarly searches the first table 13 using the first 6 bits of the bit string “010001” as an address. Herein, the address “010001” is found in Line 2 (refer to FIG. 14). After transferring the data in the Line 2 from the main memory 10 to the cache memory 34, it is therefore necessary to access the data.

Here, since there is no space in the cache memory 34 now, it is necessary to write back data of any lines stored in the cache memory 34 to the main memory 10, and to transfer the data in the Line 2 to the space generated by the write-back.

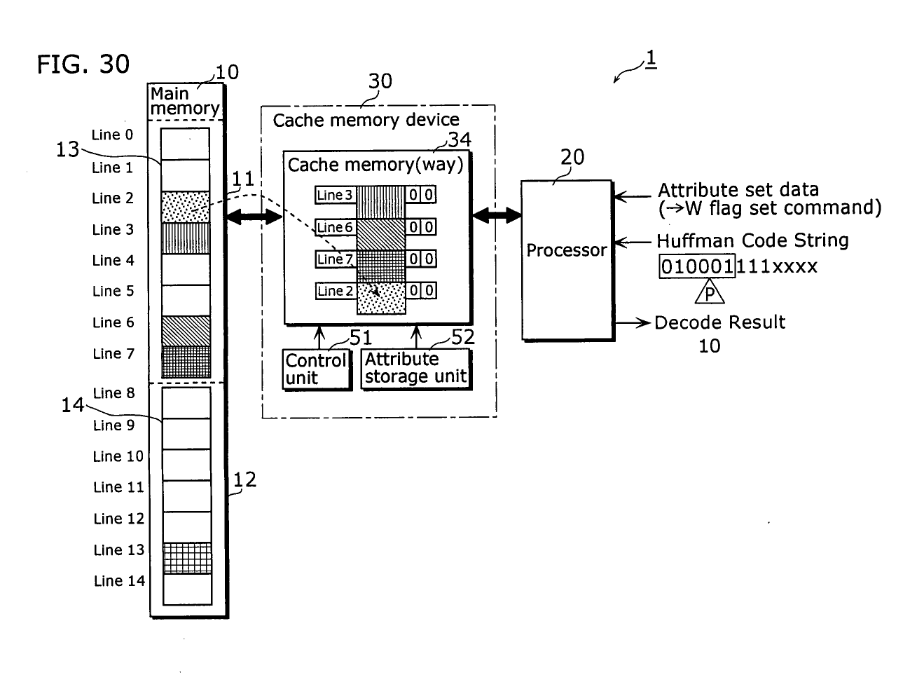

Here, the control unit 51 determines which one of data of line stored in the cache memory 34 to be written back to the main memory 10 based on intensity information of the first memory area 11 and the second memory area 12 of the main memory 10 specified by the attribute storage unit 52. In this case, it is shown that the intensity from the Line 0 to the Line 7 which form the first table 13 is large, and that the intensity from the Line 8 to the Line 14 which form the second table 14 is small (refer to FIG. 16). Therefore, the data in the second table 14 and stored in the current cash memory 34 is written back in the main memory 10. That is, the data of the current Line 13 is stored in the cache memory 34 so that said data is written back in the main memory 10 (FIG. 29) and the data of the Line 2 is transferred to the space generated by the write-back (FIG. 30).

After that, the processor 20 accesses the data of the Line 2 and obtains the code length 4 bits and the result of decoding 10. Since the code length is 4 bits, the codes composed of 4 bits are removed from the bit string so that the bit string becomes “01111xxxx”.

In this procedure, it is explained that the data of the Line 13 is written back from the cache memory 34 to the main memory 10. However, in the procedure of a series of operations, the value of data of the Line 13 has not changed while being stored in the cache memory 34, that is, the value in the cache memory and the value in the main memory 10 are the same. Therefore, most of the conventional method of controlling cache memory does not have an operation of write-back so that the data of the Line 2 is written over the data of the Line 13.

That is, when there is no space in the cache memory 34, by the LRU method, the data of the Line 3 is determined as a replacement target and the data of the Line 2 is written over the line. In contrast, the control unit 51 in the first embodiment searches a line whose weak flag W of the cache memory 34 is set to “1” and determines the data of the Line 13 as a replacement target. The control unit 51 then verifies that the value of the dirty flag D of the Line 13 has remained as “0”, and writes the data of the Line 2 on the Line.

Consequently, the data which is more frequently accessed remains in the cache memory 34 so that the hit frequency gets higher and the probability of cash misses is lowered.

When the next bit string is “01111xxxx”, the processor 20 similarly searches the first table 13 using the first 6 bits of the bit string as an address. Herein, the address “01111x” is found in the Line 3 (refer to FIG. 14). The data of the Line 3 is stored in the cache memory 34. Therefore there is a hit. The processor 20 then soon accesses the data at the address “01111x”, and obtains the code length 5 bits and the result of decoding 16.

In the procedure, by the conventional technology, the line accessed most recently is usually written back when there is no space in the cash memory 34. Therefore, the data of the Line 3 is repeatedly transferred between the main memory 10 and the cache memory 34 for several times. However, owing to the roles of the control unit 51 (replace unit 42a) and the attribute storage unit 52 (W flag set unit 42b), it is controlled so that the data which is more frequently accessed is preferentially remained in the data area of the cache memory 34. As a consequence, the number of data transfers between the main memory 10 and the cache memory 34 can be reduced.

As described in the above, according to the first embodiment, the number of data transfers between the main memory 10 and the cache memory 34 can be reduced by allocating a space by the control unit 51 while preferentially holding data in a first memory area 11 (first table 13) in the cache memory 34, using the first memory area 11 of the main memory 10, the second memory area 12, the cache memory 34 which temporarily stores the data in the memory areas 11 and 12, the processor 20 for accessing the first and second memory areas 11 and 12 via the cache memory 34, and the control unit 51 which allocates a space when there is a lack of spaces in the cache memory 34.

Note that, it is explained that the Huffman decoding in the present embodiment is a processing that the decoding is completed by one of following two types of procedures that: i) decoding is completed by accessing the first memory area 11 once; or that ii) decoding is completed by accessing the second memory area 12 once after accessing the first memory area 11. However, it is not necessarily to be such procedures.

For example, as disclosed in Japanese Laid-Open Patent Publication No. 2000-286717 (first embodiment), it may be a processing that the decoding is completed by accessing a memory once, or if not, a processing that the decoding is completed by accessing the memory more than once. In this case, for example, a memory area where has a possibility to be accessed for the first time may be assigned as the first memory area 11 in the present embodiment. Also, a memory area where has a possibility to be accessed for the second time or later may be assigned as the second memory area 12 in the present embodiment.

Alternatively, in the case where a relatively small integer is defined as m, there is a method that memory area which has a possibility to be accessed by the m-th time is assigned to the memory area 11 in the present embodiment and a memory area which has a possibility to be accessed after the m-th time is assigned to the second area 12 in the present embodiment.

Also in this case, the number of transfers between the main memory 10 and the cache memory 34 can be largely reduced from before by allocating a space while preferentially holding the data in the first memory (first table 5000).

### Second Embodiment

Next, a signal processing apparatus 2 according to the second embodiment of the present invention is explained.

Now, the signal processing apparatus 1 in the first embodiment sets the control unit 51 so as not to leave data which is less frequently accessed in the cache memory. That is, in the signal processing apparatus, the data in the second table 14 is first stored in the cache memory 34 and the data is used for a replacement when there is no space in the cash memory 34.

However, it lowers the probability of the data in the first table 13 to exist in the cash memory 34 as much as the replacements. That is, an area assigned for the data in the first table 13 is reduced.

Accordingly, it is controlled that the data which is originally less frequently accessed to be not to be stored in the cache memory.

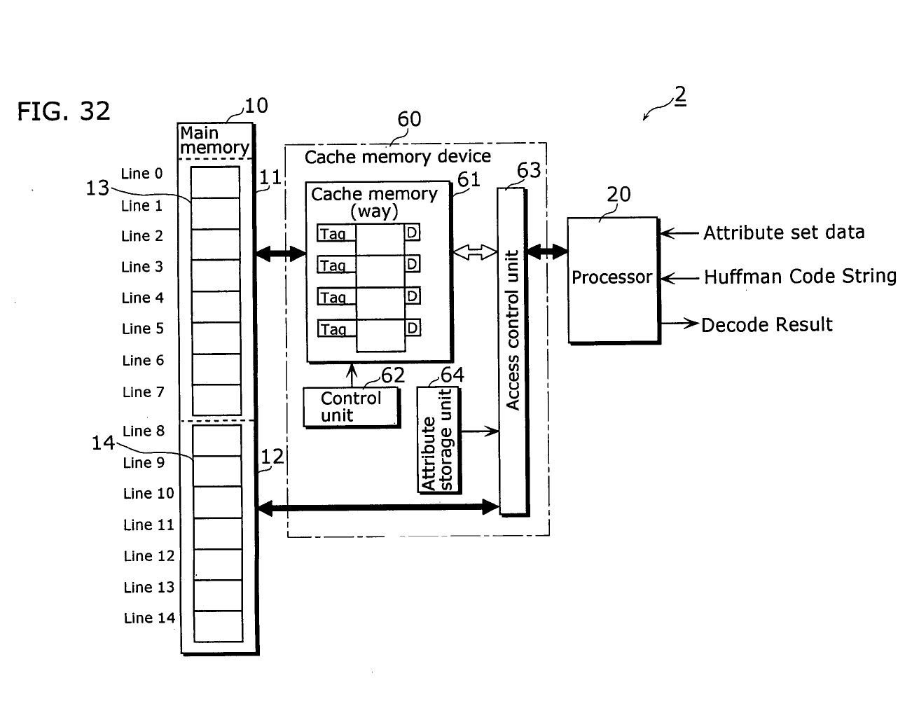

FIG. 32 shows a structure for that case.

That is, as shown in FIG. 32, the signal processing apparatus 2 has a main memory 10, a processor 20 and a cache memory device 60 having a function of accessing the main memory 10 via a cache memory and a function of accessing the main memory 10 without going through the cache memory. The main memory 1 formed of a first table 13 stored in the first memory area 11 of the main memory 10 and of a second table 14 which can be accessed without going through the cache memory.

The cache memory device 60 is formed of a cache memory 61, a control unit 62, an access control unit 63, an attribute storage unit 64, and the like.

The cache memory 61 has a structure from which the weak flag W is deleted from the cache memory 34.

The control unit 62 determines a replacement target by an ordinal LRU method.

The attribute storage unit 64 stores data which is more frequently accessed based on a command which set an attribute outputted from the processor 20.

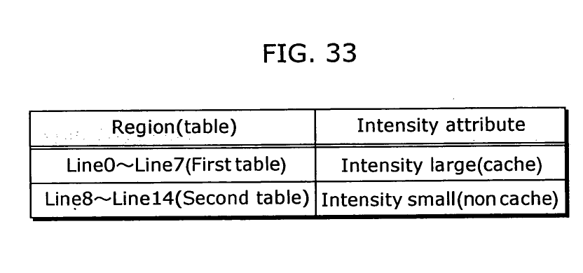

FIG. 33 is a diagram showing an example of details of the attribute data stored in the attribute storage unit 64.

Herein, it is indicated that the intensity from the Line 0 to Line 7 formed of the first table 13 is high (cache) and the intensity from the Line 8 to the Line 14 formed of the second table 14 is less (non-cache). By setting such intensity attributes, an appropriate replacement algorithm is exercised reducing the cache misses.

The access control unit 63 determines whether accesses via the cache memory 61 or accesses the second table 14 based on the data stored in the attribute storage unit 64. In specific, when the address to which the processor 20 accesses is in the rage from the Line 0 to Line 7, the access control unit 63 enables the cache memory 61 and intermediates to read data of the Line 0 to Line 7 via the cache memory 61. When the address to which the processor 20 accesses is in the rage from the Line 8 to Line 14, the access control unit 63 disables the cache memory 61, directly accesses the data at the address in the second table 14 stored in the second memory area 12 of the main memory 10, and outputs the read data to the processor 20.

Owing to such structure, the processor 20 can access via the cache memory when accessing the first table 13 via the cache memory 61, and can access without going through the cache memory 61 when accessing the second table 14. Therefore, it can be prevented that the data which is less frequently accessed in the second table 14 is not to be stored in the cache memory 61.

Accordingly, if the data of the first table 13 which is more frequently accessed is once stored in the cache memory, it is highly likely to be kept being stored. As the consequence, the number of data transfers between the main memory 10 and the cache memory 61 can be reduced.

<Variation>

Here, the cache memory in the present invention is not only limited to the structure described in the first embodiment, but variations are allowed. Hereafter, it is explained about some of the variations.

(1) In the first embodiment, the weak flag W indicates that an access order is the oldest. However, it may indicate that the access order is neither the latest nor the oldest. Herein, the replace unit 42a considers that the cache entry of W=1 is not the oldest so that it does not select the cache entry but select other cache entry. The waste replace can be prevented by adding the weak flag W indicating that it is not the oldest to the data which is more frequently accessed or the cache entry which can hold data which is accessed on average.

(2) The processor 20 executes a special store instruction which instructs to set a weak flag W=1 and to write data. The cache control unit 42 may further include an instruction detection unit which detects a special store instruction and a flag set unit which sets to W=1 when writing in accordance with the store instruction.

(3) While in the first embodiment, a 4 way-set-associative cache memory is explained as an example, the number of ways can be any numbers. Also, while in the first embodiment, an example having the number of 16 sets is explained, the number of sets can be any.

(4) While in the first embodiment, a set-associative cache memory is explained as an example, it may be a cache memory by a full-associative method.

(5) While in the first embodiment, the size of sub-line is determined as one fourth of the size of line, it may be other sizes such as half, eighth, and sixteenth. In that case, each cash entry may respectively hold valid flags and dirty flags as many as sub-lines.

(6) Also, in the embodiments, it is explained about a case where encoded data of music data is decoded using, for example, a table corresponding to a Huffman code book (e.g. 8) on a MPEG-AAC standard. However, present invention can be applied to the case where the encoded data is decoded using a table corresponding to other code books. It can be also applied to a case where the encoded data such as MP3 and the like is decoded. Further, not to mention that it can be applied to various signal processing such as decoding compressed and coded video data and the like.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The signal processing apparatus according to the present invention is useful for an appliance that is made up of a processor and a storage device, reduces cash misses, and has an effect of reducing time and amount of data transfers between a cache memory and a main memory, for example, for a personal computer and the like. In addition, it can be applied for a use of an appliance which processes a digitalized audio signal and a video signal by a processor and a storage device, for example, a digital television, a DVD appliance, a cellular phone, a mobile information terminal, a headphone stereo and the like.

1. A signal processing apparatus which performs signal processing using data in first and second memory areas, said signal processing apparatus comprising:
a cache memory for temporarily holding the data;
an access unit operable to read out the data by accessing at least one of the first and second memory areas via said cache memory; and
a control unit operable to allocate a space in said cache memory in the case where there is a lack of the space for temporarily holding the data in said cache memory,
wherein said control unit is operable to allocate the space into which the data in the first memory area is stored preferentially to the data in the second memory area.

2. The signal processing apparatus according to claim 1, further comprising
an attribute storage unit operable to hold an intensity attribute indicating that the first memory area has a stronger data-persistent intensity than the second memory area,
wherein said control unit is operable to determine data to be stored in said cache memory in accordance with the intensity attribute stored in said attribute storage unit.

3. The signal processing apparatus according to claim 1,
wherein said access unit accesses i) the first memory area after transferring the data in the first memory area to said cache memory and ii) the second memory area without transferring the data in the second memory area to said cache memory.

4. The signal processing apparatus according to claim 1,
wherein the first memory area holds data which is more frequently accessed than in the second memory area.

5. The signal processing apparatus according to claim 1,
wherein the first and second memory areas respectively have first and second tables indicating conversion rules for converting input data in accordance with a predetermined rule, and
said control unit is operable to allocate the space so that the data in the second table is discarded from said cache memory preferentially to the data in the first table.

6. The signal processing apparatus according to claim 5, further comprising
an attribute storage unit operable to hold an intensity attribute indicating that the first table has a stronger data-persistent intensity than the second table,
wherein said control unit is operable to determine data to be discarded from said cache memory in accordance with the intensity attribute stored in said attribute storage unit.

7. The signal processing apparatus according to claim 5,
wherein said signal processing apparatus decodes a Huffman code that is input data,
a longest code length of the Huffman code is N bits,
the first table is a table for decoding coded data of n bits or smaller, where n is an integer that is 1 or greater and smaller than N, and
the second table is a table for decoding coded data that is longer than n bits.

8. A control method for use in a cache memory apparatus including first and second memory areas, a cache memory for temporarily holding data, and an access unit that reads out the data by accessing the first and second memory areas via the cache memory, said method comprising
allocating a space for temporarily holding the data in the cache memory in the case where there is a lack of the space into which the data in the first memory area is stored preferentially to the data in the second memory area.

9. A program for use in a signal processing apparatus which performs signal processing using the data in the first and second memory areas, the program causing a computer to execute
allocating a space for temporarily holding the data in the cache memory in the case where there is a lack of the space into which the data in the first memory area is stored preferentially to the data in the second memory area.
